(19) United States
(12) Patent Application Publication
(10) Pub. No.: US 2007/0218446 A1
(43) Pub. Date: Sep. 20, 2007

(54) Student interaction management system

(76) Inventors: Burck Smith, Washington, DC (US); Charles Felmeister, Towson, MD (US); Lukasz Galeeki, Boulder, CO (US); Kirk Benningfield, Alexandria, VA (US)

Correspondence Address: Jon L. Roberts;ROBERTS MARDULA & WERTHEIM, LLC, Suite 1000, 11800 Sunrise Valley Drive, Reston, VA, 20191-5302, US

(21) Appl. No.: 11/367,284

(22) Filed: Mar. 3, 2006

(51) Int. Cl. G09B 3/00

(52) U.S. Cl. 434/350

(57) ABSTRACT

A system and method for providing a tutoring service over a network comprises a tutoring application server on the network that is capable of serving one or more student interfaces and tutor interfaces over the network. In use, the tutoring application server matches an available tutor in a subject to a student seeking assistance in the subject with a highest priority. It then provides a common template in the form of a whiteboard application that both a matched tutor and student can use to write and draw to interact with one another. A mathematical algorithm that factors: priority for an affiliate institution that uses the system, tutor subject weight, and student time in queue is used to match a student with the highest priority to an available tutor.

### BACKGROUND

Embodiments of the present invention relate generally to an on-line tutoring system, and more particularly to a real-time, interactive on-line tutoring system. Traditionally, tutoring of pupils has involved pairing of tutors with students based upon a student's needs and a tutor's expertise. Once paired, the tutor and student would meet in person for instruction by the tutor. If a student required assistance with multiple subjects, multiple tutors were required in order to provide the student with a tutor having expertise in the desired subject area. While this type of in-person tutoring can provide effective and personalized service to the student, it can be expensive due to the need for students and tutors to meet in person at a mutually convenient time.

In recent years, various on-line instruction systems have been developed. Conventional on-line instruction systems have been limited to a student unilaterally performing learning exercises on a user interface, such as a computer terminal. While these conventional on-line instruction systems provide asynchronous learning, they lacked the interaction of one human being with another. Thus, the conventional on-line instruction systems have not provided a fully interactive experience between the tutor and the student. Conventional on-line instruction systems have also not contemplated those instances where a student may require tutoring in multiple subjects and thus may require either a single tutor with expertise in multiple subject areas or several tutors who may provide tutoring in succession.

### SUMMARY

The invention provides for an interactive on-line tutoring system that provides for synchronous and asynchronous human instruction that integrates the functionality needed for students, tutors, tutor managers, and administrators.

Tutor Functionality

The tutor functionality of the present invention allows tutors to interact with students and perform administrative functions necessary to perform their tasks. Each tutor has a tutor account that comprises a profile of that tutor. For example, a tutor may be qualified to teach in only one subject, or may have qualifications to teach in more than one subject.

Each tutor is trained and tested in the subject matter in which the tutor desires to teach. Training is periodic and records are kept of the training that is received. Records are also kept on the subject matter for which the tutor is qualified. In that way, students needing assistance can be assigned when the tutor is on line.

Tutors are paid for the time that they assist students and for other qualified administrative tasks. When a tutor signs on to the system, records are kept of the tutor's activities. For example, the tutor can sign on and view a queue of students awaiting assistance and the topics in which they are requesting assistance. The tutor can then initiate a session with the student and interact according to the needs of the student.

Since not all questions need to be answered in a synchronous session, a student can list questions for response at a later time, or an asynchronous session. In such a case, a tutor not having a “live” student session, can access the asynchronous question queue and respond to those questions within the tutorial system. In either case, the tutor's activities are logged and paid for according to the time spent on those activities.

Student Functionality

The student functionality of the present invention allows students to interact with tutors in a variety of ways. Each student has a student account and logs into the system using the account to obtain the tutoring services. Upon entry to the system, the student can choose the type of assistance they require. The student can: “drop in” and work with a tutor; submit a piece of writing for any subject to the system's online writing lab; submit a question and get a response from a tutor, usually within 24 hours; schedule an appointment with a tutor; or use the system's online study resources.

For a drop in session, the student logs into the system and requests a tutoring session in an available subject. The request is put into a queue to match the student with a tutor and the student then waits for a suitable tutor to become available. The drop in tutoring session is then conducted in an interactive manner using a whiteboard application accessed by the student and tutor. Upon completion, the student can choose a different subject and work with an appropriate tutor in that subject.

If a student does not wish to wait online or wants to have a session with a preferred tutor, the student can log into the system and schedule a session at a future timeslot with a particular tutor and then return to the system at the scheduled time for an interactive session with the tutor using the system's whiteboard application. The student can also save his work for future visits, eliminating the need for re-entry of the question

For interactive assistance with written work, a student can submit a piece of writing to an online writing lab that is staffed with writing tutors. Students then receive a detailed, personalized critique of any written assignment, such as an essay, report, personal statement, cover letter, resume, or creative story. Students may choose a specific amount of time for the session, such as a 30-minute review or a 60-minute review for longer essays. Students can also receive a detailed critique of practice test essays, such as SAT essays. The tutor's critique identifies an essay's strengths, notes its weaknesses, and provides a sample score.

For less interactive assistance, the student can submit questions for later answer by a tutor. The student posts the question to the system by selecting a subject area and submitting the question with the system's whiteboard application. A qualified tutor will then post comments or answers to the question to the whiteboard application so that the student can log in at a later time to view the answer.

Students can use various other resources provided by the system. They can search a schedule of available tutoring sessions to browse through all drop-in sessions and enter those currently available or view and/or edit pre-scheduled sessions. Whiteboard sessions can also be used for various activities and are saved by the system for later review by the student, by the student's school, or by the tutor manager. As such, additional student functionality can be provided using the whiteboard application to administer tests or practice tests online, to review previous tests (with or without a tutor), to review previous tutoring sessions or answers (on the students initiative or after a reminder from a tutor or the system), and to keep records of student progress. Students can also use the system to access academic materials such as subject specific study guides, study skill manuals, test preparation and self assessment tools, writer's handbooks, and links to other online academic resources on the Internet. The student interface includes separate sections for connecting with a tutor, scheduling a personal session, submitting writing, submitting questions, and searching session schedules. Each of these sections includes a drop down menu to choose a subject area. The student interface also includes a section for accessing other resources.

Management/Coordinator Functionality

The present invention also provides management functionality which allows insight into how the system is being used. The management/coordinator interface can be used to see the tutors that are online and what they are doing (e.g., tutoring, answering offline questions, annotating previous sessions, waiting etc.).

The system includes a queuing module that is used to match students with tutors. The queuing module uses a weighting scheme by subject and by tutor. A multi-subject tutor has students weighted depending on the subject. For students waiting for a live session, the queuing module also uses time in queue as a factor. In the queuing process, each tutor has his own “room” and students are sent to a room only when it is available. This queuing scheme is in contrast to other systems where a student is placed in the particular queue of a particular tutor and must wait until that tutor is available. Tutor queues and tasks can be accessed by systems managers at any time to ensure that the present invention is being used to optimum effect.

Tutor managers can view sessions in progress to monitor a tutor's work during a tutoring session and can view stored sessions to review and critique the tutor. In a similar manner, if the system is used by a school to staff its own tutors, the school administrators can access student sessions to monitor progress. The design of the queuing and administrative system also allows tutor managers the ability to retrieve and answer questions-directly from the queue, and to transfer questions from one tutor to another as necessary.

Educational Institution Functionality

The system can be used in conjunction with a school or other institution in either a standard or custom configuration. In a standard configuration, a school or institution can purchase blocks of time for use by students in small increments.

Sessions that are being used by students of the school can be a great source of information on student needs and educational effectiveness. For example, school faculty or institution personnel can access stored sessions with students to review the student's work in sessions. In a custom configuration, access to the present invention is accomplished through a sponsored link on the school's web site.

Schools also have the capability to request that certain subjects be established for access by its students. In this way, the present invention can more accurately reflect the needs of the users of the system.

Client schools can purchase blocks of time for students through the school interface. Payment for tutor time occurs in a variety of ways customary in the art.

### DESCRIPTION OF THE DRAWINGS

FIG. 1 illustrates a block diagram of the system for on-line interactive tutoring in according to an embodiment of the present invention.

FIG. 2 illustrates a process for commencing an on-line tutorial session in according to an embodiment of the present invention; and

FIG. 3 illustrates a screen shot of a whiteboard according to an embodiment of the present invention.

FIGS. 4A-D illustrates a student home page and associated pull-down menus according to an embodiment of the present invention.

FIGS. 5A-D illustrates a tutor home page and associated pull-down menus according to an embodiment of the present invention.

FIG. 6 illustrates a block diagram of the tutor process for a whiteboard session according to an embodiment of the present invention.

FIG. 7 illustrates a block diagram of the student process for a whiteboard session accroding to an embodiment of the present invention.

FIG. 8 illustrates a block diagram of the student joining a tutor process for a whiteboard session according to an embodiment of the present invention.

FIG. 9 illustrates a block diagram of a live tutoring session according to an embodiment of the present invention.

FIG. 10 illustrates a flow chart for initiating a tutor server process for a whiteboard session according to an embodiment of the present invention.

FIG. 11 illustrates a flow chart for initiating a student server process for a whiteboard session according to an embodiment of the present invention.

FIG. 12 illustrates a flow chart for a tutor availability process according to an embodiment of the present invention.

FIG. 13 illustrates a queuing model flow chart according to an embodiment of the present invention.

FIGS. 14A-B illustrates queue handling of student-initiated events according to an embodiment of the present invention.

FIG. 15 illustrates queue handling of tutor-generated events according to an embodiment of the present invention.

FIGS. 16A-F illustrates coordinator viewer details according to an embodiment of the present invention.

FIGS. 17A-K illustrate details of a student homepage according to an embodiment of the present invention.

FIGS. 18A-E illustrate further details of a student homepage according to an embodiment of the present invention.

FIGS. 19A-M illustrate details of a tutor homepage according to an embodiment of the present invention.

### DETAILED DESCRIPTION

The following terms are used in the description that follows. The definitions are provided for clarity of understanding:
Affiliate Threshold (AT): The Affiliate Threshold is a stored value and is assigned by the system to reflect a relative priority of an Affiliate.
Waiting Threshold (WT): The Waiting Threshold is a measure of and determined by (Time in Queue/Threshold Capacity (TC))*100=Waiting Threshold.
Threshold Capacity (TC): The Threshold Capacity is a measure of how long it is acceptable for a student to wait in the queue and is determined by Affiliate Threshold+Subject Threshold.
Subject Weight (SW): The Subject Weight is a stored value in the system, assigned by the ed team to each tutor, that reflect a tutor's knowledge of a subject and its relative importance to other subjects that a tutor is certified to teach.

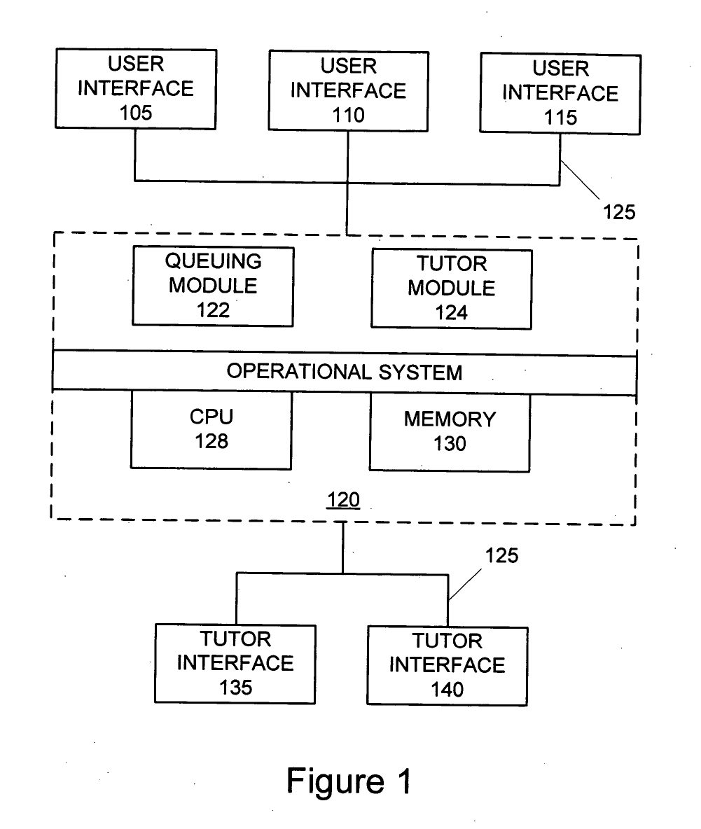

FIG. 1 illustrates a block diagram of the system for on-line interactive tutoring in accordance with the invention. FIG. 1 shows a plurality of user interfaces 105, 110 and 115 which are communicatively coupled to a tutoring application 120 via a network connection 125, such as the Internet, a local area network (LAN), a virtual private network (VPN) or other network. The user interfaces 105, 110 and 115 may include a terminal with a computer keyboard and monitor that can be accessed by users, in this case, students. FIG. 1 also shows a plurality of tutoring interfaces 135 and 140 that are communicatively coupled to the tutoring application 120 via the network connection 125. The tutoring interfaces 135 and 140 may also include a terminal with a computer keyboard and monitor that can be used by tutors to access the tutoring application 120. In accordance with the invention, tutors and students can interact with one another via the tutoring application 120.

As shown in FIG. 1, the tutoring application 120 includes a CPU 128 and memory 130 operated by systems software, including a tutoring module 124 and a queuing module 122. Both the tutoring module 124 and the queuing module 122 include graphical user interfaces (GUI) for communication with both tutors and students. The tutoring module 124 includes various functionality that allows students and tutors to interact in real time and view a common screen or whiteboard. The whiteboard acts a template that is commonly viewed by both tutors and students. Both the tutors and the students can access the common whiteboard and make notes and other comments which are viewable to one another. The various functionalities associated with the whiteboard will be described below in greater detail.

The queuing module 122, which is described in greater detail below, determines which tutors are best suited to which students. The tutoring module 124 includes information about each student's grade level and subject areas of interest along with information about each tutor, including their respective areas of expertise. The tutoring module 124 will pair each student seeking instruction with a tutor whose qualifications match that particular student's needs. The tutoring module 124 also facilitates the scheduling of the tutoring sessions based upon the student's and the tutor's availability. The tutoring module 124 also provides additional functionality, including shift reporting, which refers to the collection of tutor and student sign-in and sign-out times; student data; and the number of students served. Tutors can also provide comments about each student, including feedback about a student's progress.

Tutors often have multiple subjects in which they can tutor. Students in some cases may have a need for tutoring in a single subject, while other students may have a need for tutoring in multiple subjects. Students logging onto the system are placed into a line for all subjects. The queuing module 124 includes an algorithm that selects the best available tutor that will meet a students needs. In accordance with the invention, the queuing algorithm uses four variables to match students with tutors. The four variables include: the amount of time in queue, which is determined by a student's submission time; affiliate threshold, which is set by the operator; subject threshold, which is set by the operator; and subject weight, which is also set the operator for each subject tutored by a tutor. The combination of these factors is designed to produce a balance between the shortest possible waiting time for a student and the best match of tutoring skills with the student's requirements. For example, a student requiring assistance with a differential calculus problem, may wait slightly longer than would be expected by viewing waiting time alone, if the algorithm determines that a tutor with specific differential calculus skills will soon be available.

The queuing algorithm can be described as follows: When a student enters the queue, they are assigning a Waiting Threshold (WT). The Waiting Threshold is determined by the following calculation:
(Time in Queue/Threshold Capacity (TC))*100=Waiting Threshold
Threshold Capacity (TC)=Affiliate Threshold+Subject Threshold

By introducing the concept of Threshold Capacity, the system is able to provide priorities to certain affiliates and subjects. The higher the TC value, the longer it is acceptable for a student to Wait in the queue.

When a tutor is ready to accept a student, the system will retrieve Subject Weight (SW) for each subject that the tutor's current board is open to. SW are stored values in the system, assigned by the ed team to each tutor, that reflect an tutor's knowledge of a subject and it's relative importance to other subject that the tutor is certified for. An example follows:
Tutor 1 profile
   SW Calculus=100
   SW Trigonometry=75

This will allow for a tutor who has a board open in trigonometry and calculus to receive a high frequency of trigonometry students because there are fewer tutors available.

Once the SW is retrieved, all students with matching subjects are retrieved from the queue as well. Based on the ratio of these to values, the relative student priority (SP) is calculated for that specific tutor.
Waiting Threshold/SW*100=Student Priority (SP)
Based on the SP value, the tutor is matched with the student who has the highest priority. The following cases provide additional examples of the functioning of the algorithm:
Case 1
3 Students
1 Tutor

All Affiliates are Equal and All Subjects are Equal

| | | Waiting | Affiliate | Subject | Waiting |
|---|---|---|---|---|---|
| | Subject | Time | Threshold | Threshold | Threshold |
| Student | A | 5 min | 10 | 5 | 33 |
| 1 | | | | | |
| Student | B | 10 min | 10 | 5 | 67 |
| 2 | | | | | |
| Student | C | 15 min | 10 | 5 | 100 |
| 3 | | | | | |

Tutor 1
SW Subject A—100
SW Subject B—100
SW Subject C—100

Relative Priorities

| | Subject | WT | SW | SP |
|---|---|---|---|---|
| Student 1 | A | 33 | 100 | 33 |
| Student 2 | B | 67 | 100 | 67 |
| Student 3 | C | 100 | 100 | 100 |

Tutor receives Student 3.
Case 2
3 Students
1 Tutor

Affiliates are Unequal and All Subjects are Equal

| | | Waiting | Affiliate | Subject | Waiting |
|---|---|---|---|---|---|
| | Subject | Time | Threshold | Threshold | Threshold |
| Student | A | 5 min | 10 | 5 | 33 |
| 1 | | | | | |
| Student | B | 10 min | 4 | 5 | 111 |
| 2 | | | | | |
| Student | C | 15 min | 10 | 5 | 100 |
| 3 | | | | | |

Tutor 1
SW Subject A—100
SW Subject B—100
SW Subject C—100

Relative Priorities

| | Subject | WT | SW | SP |
|---|---|---|---|---|
| Student 1 | A | 33 | 100 | 33 |
| Student 2 | B | 111 | 100 | 111 |
| Student 3 | C | 100 | 100 | 100 |

Tutor receives Student 2.
Case 3
3 Students
1 Tutor

Affiliates are Equal and Subjects are Unequal

| | | Waiting | Affiliate | Subject | Waiting |
|---|---|---|---|---|---|
| | Subject | Time | Threshold | Threshold | Threshold |
| Student | A | 5 min | 10 | 5 | 33 |
| 1 | | | | | |
| Student | B | 10 min | 10 | 5 | 67 |
| 2 | | | | | |
| Student | C | 15 min | 10 | 15 | 60 |
| 3 | | | | | |

Tutor 1
SW Subject A—100
SW Subject B—100
SW Subject C—100

Relative Priorities

| | Subject | WT | SW | SP |
|---|---|---|---|---|
| Student 1 | A | 33 | 100 | 33 |
| Student 2 | B | 67 | 100 | 67 |
| Student 3 | C | 60 | 100 | 60 |

Tutor receives Student 2.
Case 4
3 Students
1 Tutor

Affiliates are Equal and Subjects Equal, Tutor Subject Weight is Different

| | | Waiting | Affiliate | Subject | Waiting |
|---|---|---|---|---|---|
| | Subject | Time | Threshold | Threshold | Threshold |
| Student | A | 5 min | 10 | 5 | 33 |
| 1 | | | | | |
| Student | B | 10 min | 10 | 5 | 67 |
| 2 | | | | | |
| Student | C | 15 min | 10 | 5 | 100 |
| 3 | | | | | |

Tutor 1
SW Subject A—90
SW Subject B—75
SW Subject C—90

Relative Priorities

| | Subject | WT | SW | SP |
|---|---|---|---|---|
| Student 1 | A | 33 | 90 | 37 |
| Student 2 | B | 67 | 75 | 89 |
| Student 3 | C | 60 | 90 | 67 |

Tutor receives Student 2.

The examples shown above illustrate that by modifying Threshold Capacity, the system is able to prioritize students and by assigning subject weights to tutors, the system is able to ensure that tutors who have a high level of expertise in a given subject will receive a greater frequency of students in that area. In this manner, tutors are matched with students in an efficient manner so as to reduce the amount of time students have to wait in the event that a large number of students are seeking tutor assistance.

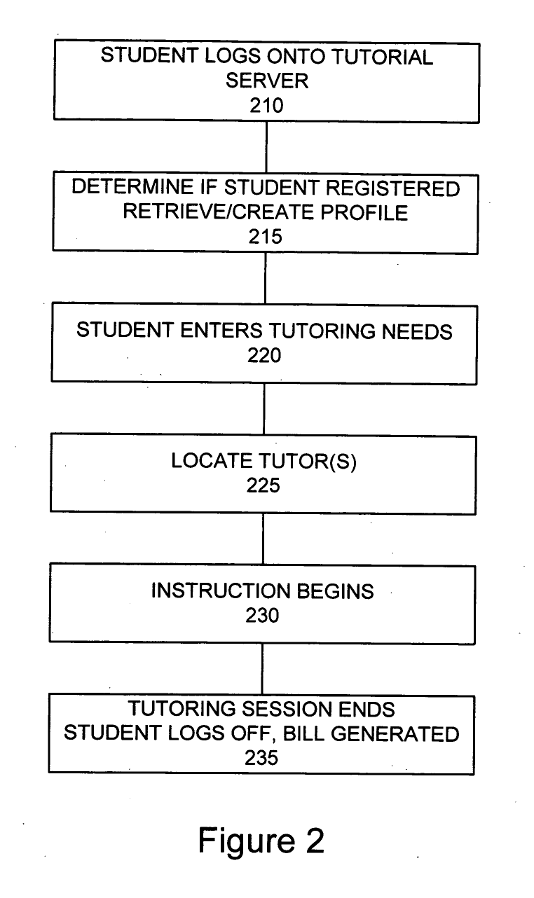

FIG. 2 illustrates a process for facilitating real-time (i.e., synchronous), on-line tutorial instruction in accordance with the invention. In FIG. 2, the process begins at 210 when the student logs onto the tutorial server via a standard user interface, such as a computer coupled to a computer network. At this time various tutors are already logged in to the server and are ready to provide tutorial services based upon a student's request.

Upon logging-in, the system determines the subjects and features available to the student. This determination is based upon the type of password used to log-in. 215. The system locates the first available tutor that meets the student's tutor request 225. The tutor is selected in accordance with the queuing algorithm described above in connection with FIG. 1. In this manner, the student is paired with the first available tutor that is qualified to provide instruction in the subject or subjects requested by the student. If there is no tutor immediately available, the student is asked to wait and can be provided with an estimated wait time and can be allowed to upload previously loaded flash movies for viewing. The tutor provides real-time instruction to the student 230. The tutoring session is completed and the student can log off 235. At this time, the system determines the duration of the tutoring session, saves the session, and a billing transaction is generated for the tutoring services. The process then ends.

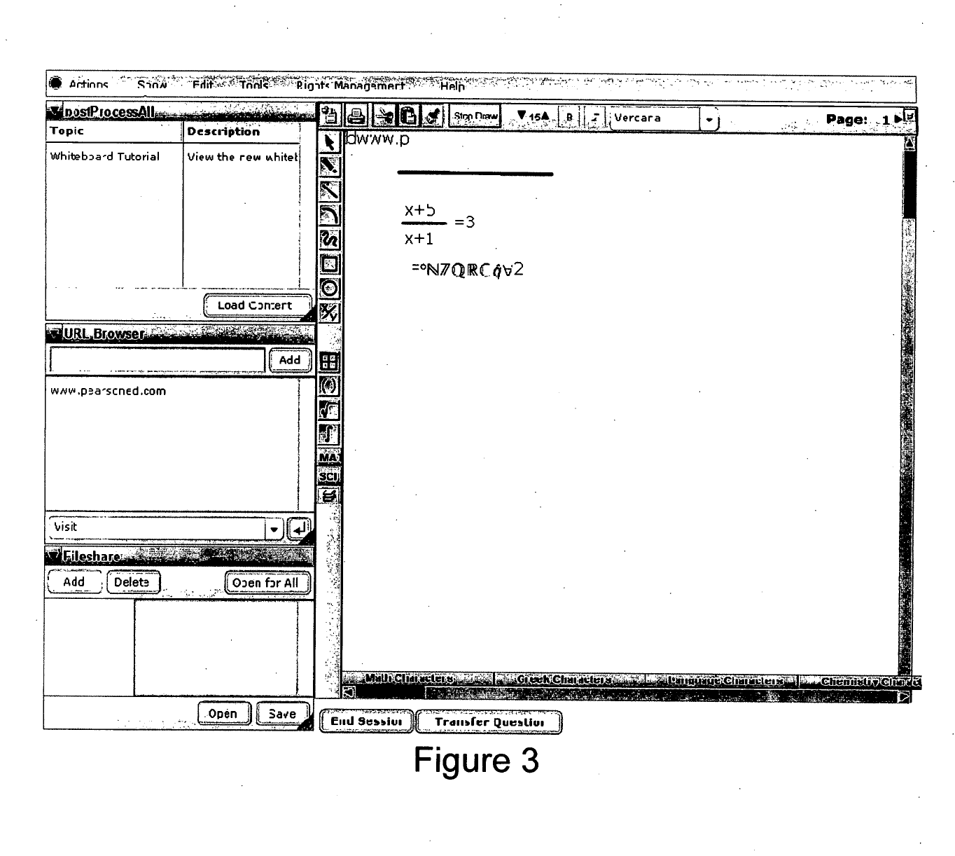

FIG. 3 illustrates an example of the whiteboard in accordance with the invention. The whiteboard provides a common template that both the tutor and student can use simultaneously and in real time to write and draw. Actions taken by one party are visible to the other. In this manner, the both notes written by a tutor and by a student are visible to one another in real time. In one embodiment, text written by the tutor will be in a different color than text written by a student.

The whiteboard of FIG. 3 includes various editing functions on the top and a list of drawing and typing tools (toolbar) on the side. The bottom of the board includes various movable menus. The toolbar is made of various icons that represent various functionalities. For example, the whiteboard in accordance with the invention provides a science palette that includes symbols such as batteries, resistors, capacitors, an AC generator, concave, convex, wedge, dotted wedge, double line, triple line and aromatic hydrocarbon symbols. These symbols allow students and tutors to draw various scientific representations on the whiteboard. The whiteboard tool bar also includes a rotation function through which various symbols can be rotated. In an embodiment of the present invention, the user input is received from a drawing pad.

In addition, the whiteboard also includes a polygon tool which allows a user to insert a polygon onto the whiteboard and whereby the number of sides can be varied by the user. The whiteboard has been designed to allow rapid modification and customization “tools” that are required for a variety of educational requirements. For example, a tool-set specifically designed for process modeling could be incorporated into the whiteboard in a matter of hours. The whiteboard illustrated in FIG. 3 is a tutor whiteboard and shows a post processing window, although various other windows, such as ones showing lists of students in the queue, archived sessions, offline questions, URLs, files for sharing, etc. can also be displayed. A whiteboard for a student who is waiting for a tutor includes an estimated wait time display (not shown). This displays an estimated wait time for students waiting for the next available tutor. In an embodiment of the invention, the wait time display may be updated to reflect the latest wait time estimate.

Utilizing the white board, the tutor can also view student archives during the tutoring session. These archives include both previous tutoring sessions and assessment results. Tutors also have the ability to prevent students from typing or drawing by using a “stop draw” button that appears on the whiteboard. The system in accordance with the invention also allows tutors to look at questions and transfer them to the next available tutor.

The system also provides functionality to save and reuse questions. This means that students only need to type a question once and if a tutor is unavailable or the student exits prior to receiving tutoring, the question is saved until a tutor becomes available or the student returns. The system also maintains visual archives of each tutoring session. This allows students to review their sessions.

The whiteboard also displays an ‘end session’ key that allows students to exit the tutoring session at the appropriate time.

The system also provides various functions available to the tutor during those times when an actual tutoring session is not taking place. While waiting to be paired with a student, the tutor can work offline on questions that have been posted by students; annotate and title previous tutoring sessions and view archives. The tutor will be automatically placed into a live tutoring session if a student arrives and he or she is paired with that tutor. Any offline work in progress is automatically saved. The tutor can also chose to “Close” the tutoring room to prevent entry of any other students. This is useful for tutors at the end of their scheduled sessions.

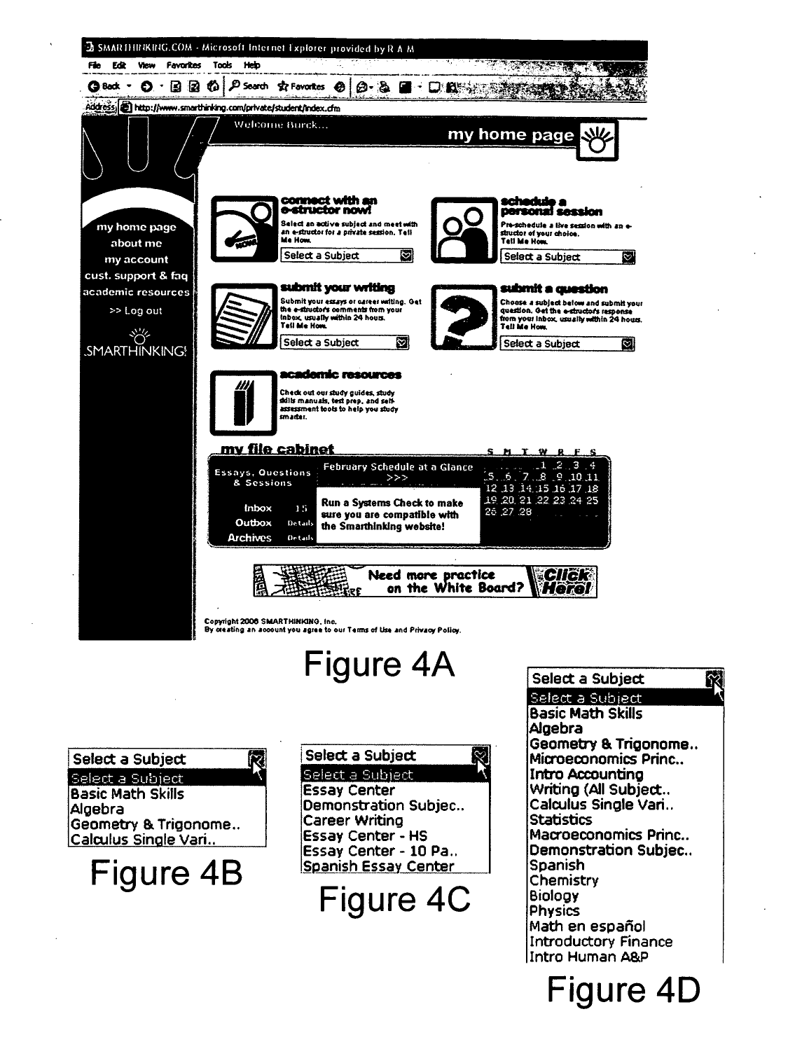

FIG. 4A illustrates an embodiment of the GUI used for a student home page. Links on the left side of the page allow the student to access and modify their profile (“about me” link), view their account status (“my account” link), access support “cust. support & faq” link), access academic resources (“academic resources” link), exit the system (“log out” link), and return to the student's main home page (“my home page” link). The main portion of the student home page comprises icons for connecting with a tutor, scheduling a tutoring session, submitting writing for review, submitting a question, and accessing academic resources. Each of these icons has a link to a help resource using a “Tell Me How” link. A lower portion of the homepage illustrated in FIG. 4A has an area called “my file cabinet” that links to the student's inbox, outbox, and archives. The portions for connecting with a tutor, scheduling a tutoring session, submitting writing for review, and submitting a question include subject pull-down menus relating to the subject matter for which the student is seeking guidance. As illustrated in FIG. 4B, the subject pull-down menu for connecting with a tutor is limited to the subjects that have tutors online. The pull-down menu for submitting writing, illustrated in FIG. 4C, shows the available types of writing submissions available to the student. For submitting questions and scheduling sessions, all available academic subjects are selectable from the subject pull-down menus, as illustrated in FIG. 4D.

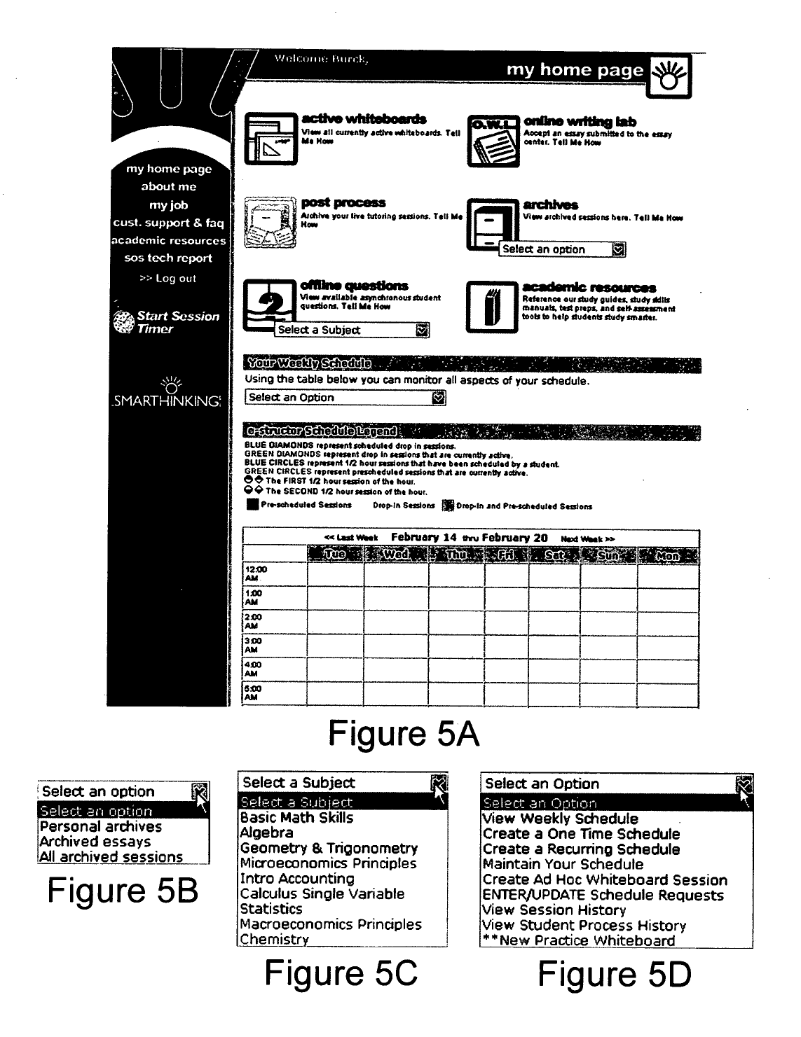

Similar to the student home page of FIG. 4A, tutors have a GUI used for a tutor home page, an embodiment of which is shown in FIG. 5A. In addition to the links on the left side of the page that are available to students, the tutor homepage includes a link to employment information for the tutor (“my job” link), a link for reporting technical problems (“sos tech report” link), and a link for keeping track of session times (“Start Session Timer” link).

The main portion of the tutor home page comprises icons for viewing all active whiteboards, accepting submissions from the online writing lab, post processing tutoring sessions, viewing archived sessions, answering offline questions submitted by students, and accessing academic resources. For viewing archives, various options are selectable using an option pull-down menu, as illustrated in FIG. 5B. The portion for viewing offline questions has a subject pull-down menu that shows which subjects have questions available for offline answering by the tutor, as illustrated in figure FIG. 5C. A lower portion of the tutor homepage has a pull-down menu for selecting various options for monitoring the tutor's weekly schedule, as shown in FIG. 5D.

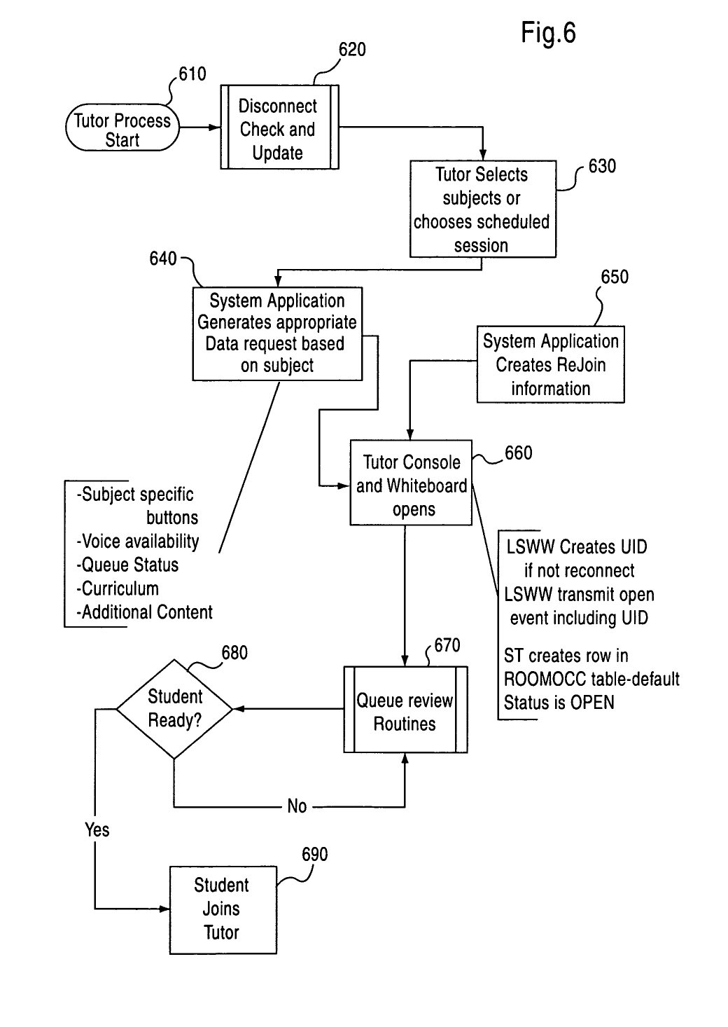

A block diagram of a tutor process for a live whiteboard session according to an embodiment of the present invention is illustrated in FIG. 6. The tutor process is begun by a tutor logging in 610 to connect to the system over a network connected to the system application. A subroutine 620 then performs a disconnect check and update which occurs periodically during a tutor session to ensure that the tutor is still signed on and active. Upon successful completion of the subroutine, the tutor is presented with a tutor interface (i.e., a GUI) that allows the tutor to interact with the system. To initiate a live whiteboard session, the tutor either selects subjects for which the tutor is qualified or chooses a scheduled session 630 from within the tutor interface, such as by making a selection from a dropdown menu. Once a selection is made the system application generates an appropriate data request 640 based upon the subject selected by the tutor. The data request 640 can include information related to subject specific buttons, voice availability, queue status, curriculum, and additional content. If the tutor chooses a scheduled session, the system application then creates ReJoin information 650 and the tutor console and whiteboard opens 660. The live whiteboard module of the system application creates a unique identifier (UID) for the live whiteboard session if it is not a reconnect and transmits an open event to the system application that includes the UID of the whiteboard session. The system application creates a row in a “room occupancy” database table (e.g., LQ_TUTORBOARDSTATE table) with a default status set to “open.”

The Queue module of the system application then performs a queue review subroutine 670 to determine the next student in the queue and the process determines whether the student is ready 680 for a live whiteboard session. If the student is not ready, the process continues subroutine 670 to check the queue until it finds a student that is ready. When the student is ready at 680, the system application performs subroutine 690 that permits the student to join the tutor in the live whiteboard session.

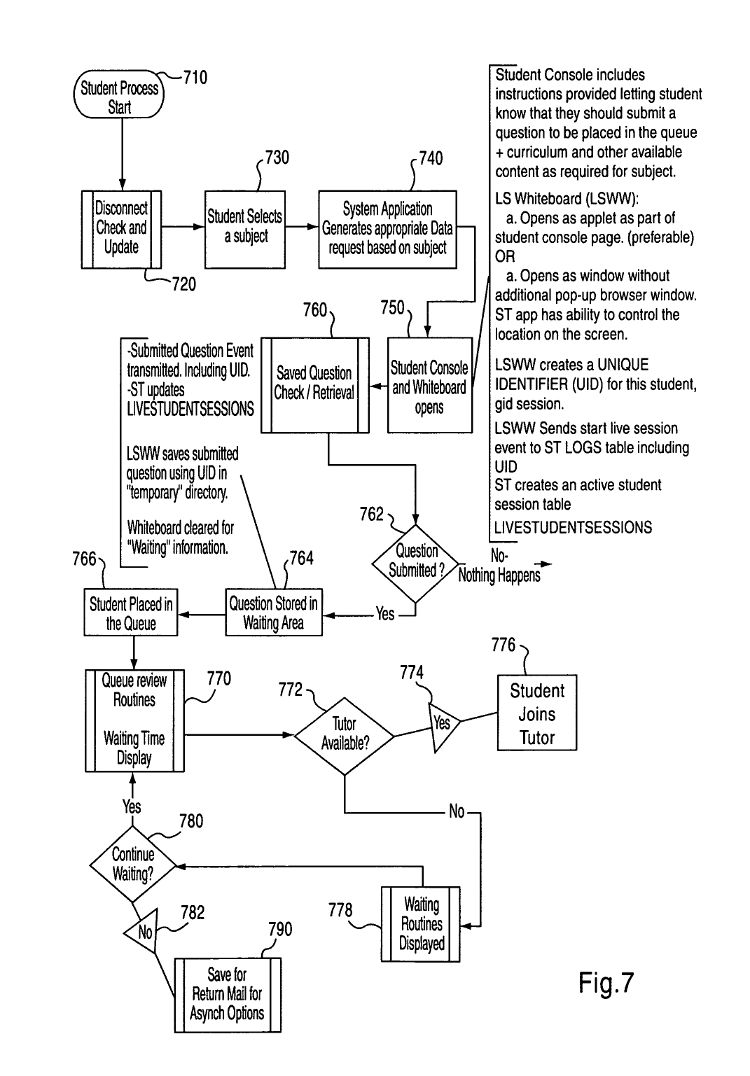

FIG. 7 illustrates a block diagram of the student process for a live whiteboard session according to an embodiment of the present invention. As with the tutor, the student process start 710 is begun by a student logging in to connect to the system over a network connected to the system application. A subroutine 720 then performs a disconnect check, which is accomplished periodically during any session to ensure that a live session is still in progress. Upon successful completion of the subroutine, the student is presented with a student interface (GUI) that allows the student to interact with the system. To initiate a live whiteboard session, the student selects a subject 730 from a dropdown in the student interface. The system application then generates an appropriate data request 740 based upon the subject and the student console and whiteboard opens 750.

The student console can provide instructions for letting the student know that they should submit a question to be placed in the queue. The student console can also provide curriculum and other available content as required for the selected subject. The live whiteboard module of the system application creates a UID for this student, creates a session identifier (STUDENTSESSIONID) for the session, and transmits a start live session event to a system application database tables (e.g., StudentSession and TutorSession tables) that includes the UID of the session and the system application creates an “active student session” database table (e.g., STUDENTSEESIONDETAIL table).

The whiteboard module of the system application can open a whiteboard in the student interface in any suitable manner. In one embodiment, the whiteboard opens as an applet or Flash control or movie as part of the student console page. In an alternate embodiment, the whiteboard opens as a window without an additional pop-up browser window. However implemented, it is desirable to have the system application be able to control the location of the whiteboard on the screen in the student interface.

After the student console and whiteboard opens at 750, the system performs a saved question check/retrieval subroutine 760 to find and retrieve any of the student's previously-saved questions. The process then determines whether a question has been submitted at 762. If not, then nothing happens. If a question has been submitted by the student, the question is stored 764 in a waiting area. When the question is stored 764, a submitted question event, including UID, is transmitted to the system application, which updates the active student session database table. Also, the whiteboard module saves the submitted question and UID in a temporary directory and the student whiteboard is cleared for “waiting” information.

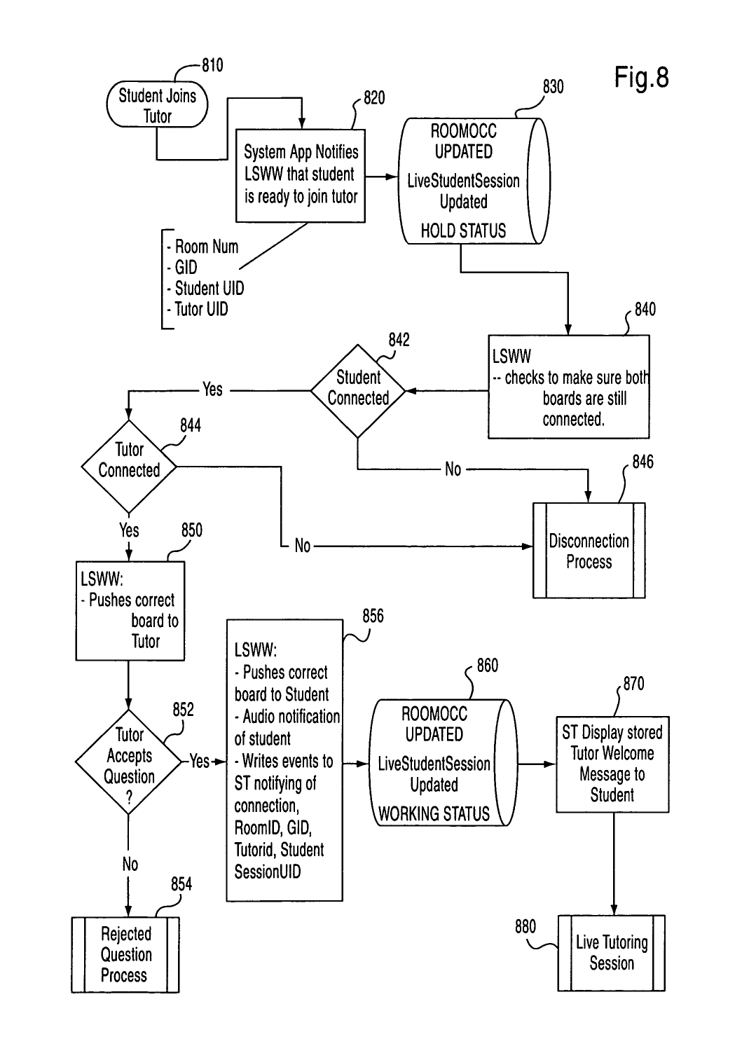

After the question is stored 764, the student is placed in the queue 766. The queue module of the system application performs a queue review and displays a waiting time at 770. The process then determines if a tutor is available at 772. If a tutor is available 774, the whiteboard module performs the subroutine 776 to have the student join the tutor in a live whiteboard session (see FIG. 8). If no tutor is available, the queue module implements a waiting subroutine 778 and the student is placed into the waiting state. The student at his option can chose to exit the waiting state at 780. The queuing algorithm is initiated each time a tutor opens a new tutoring room or completes a session with another student. The algorithm will either connect the student to an available student, or update the waiting time display 770. If the student indicates that he/she does not wish to continue waiting 782, the system application implements subroutine 790 to save the question for return or mail for asynchronous options.

A block diagram of the process of a student joining a tutor for a whiteboard session according to an embodiment of the present invention is illustrated in FIG. 8. When a student joins a tutor, as in 690 of FIG. 6 or 776 of FIG. 7, the system application notifies the whiteboard module that a student is ready to join a tutor at 820 and supplies a room number, GID, student UID, and tutor UID. The system application database is then updated at 830 to update the “room occupancy” database table (e.g., ROOMOCC table) and “active student session” database table (e.g., LQ_TUTORBOARDSTATE table) to indicate a hold status.

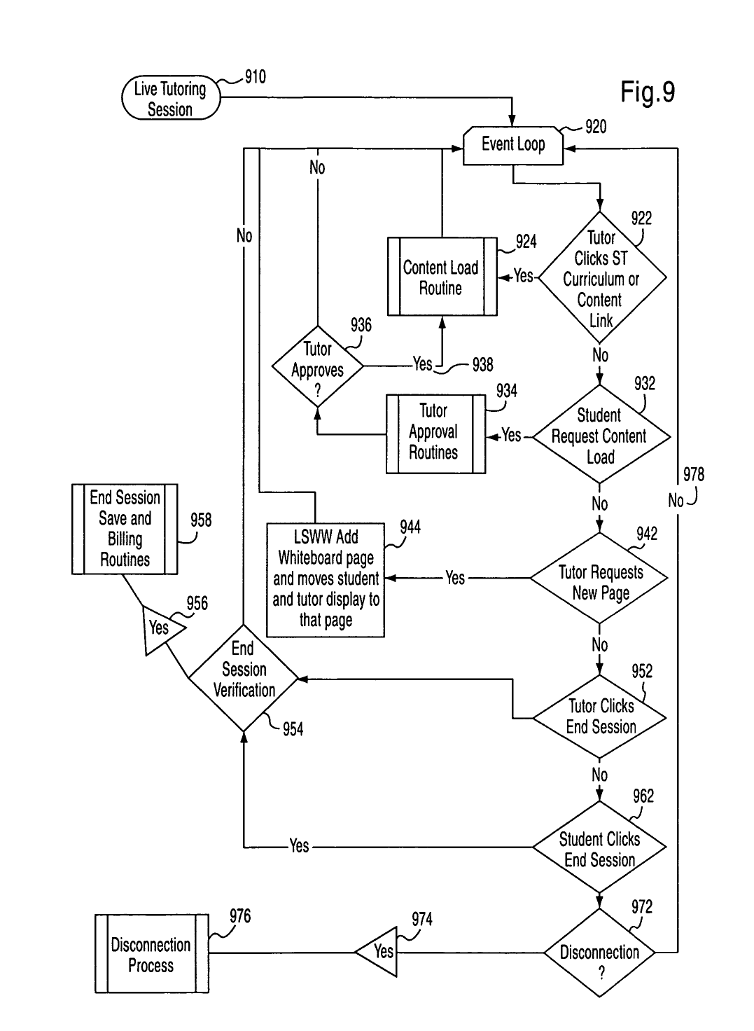

The whiteboard module then checks at 840 to make sure both boards (the student's whiteboard and tutor's whiteboard) are still connected to the system. If either a student is not connected at 842 or a tutor is not connected at 844, a disconnection subroutine 846 is performed. If both the student is connected at 842 and a tutor is connected at 844, the whiteboard module pushes the correct student whiteboard to the tutor at 850. If the tutor does not accept the question from the student whiteboard that is pushed to him/her at 852, then a rejected question subroutine 854 is performed. If the tutor accepts the question at 852, the whiteboard module performs various steps at 856, including pushing the correct board to the student, providing audio notification of the student, and writing events to the system application to notify it of the connection, room (RoomID), GID, tutor UID, and student session UID. The system application database is then updated at 860 to update the “room occupancy” database table (e.g., LQ_TUTORBOARDSTATE table) and “active student and tutor session” database tables (e.g., WB_STUDENTSESSIONS, WB_TUTORSESSIONS tables) to indicate a working status. The system application displays a stored tutor welcome message to the student at 870 and a subroutine 880 for a live tutoring session using the shared whiteboard is run, as illustrated in greater detail in FIG. 9.

FIG. 9 illustrates a block diagram of a live tutoring session according to an embodiment of the present invention. The live tutoring session 910 involves an event loop 920 that first determines at 922 whether the tutor selects a system curriculum or content link. If so, the selected content is loaded at 924 and the process returns to the start of event loop 920. If the tutor has not made a selection at 922, the process determines whether the student has requested content be loaded at 932. If so, a tutor approval subroutine 934 is run. If the tutor approves at 936, the selected content is loaded at 924 and the process returns to the event loop 920. If the tutor does not approve at 936, the process returns to the start of event loop 920.

If the student has not made a content load selection at 932, the process determines whether the tutor has requested a new page at 942. If so, the whiteboard module adds a whiteboard page and moves the student and tutor displays to the new page at 944. The process then returns to the start of event loop 920. If a new page has not been requested at 942, the process determines whether the tutor has selected to end the session at 952 or the student has selected to end the session at 962. If neither has occurred, the process checks for any disconnections at 972 and if no disconnection is found, the process returns to the start of event loop 920.

If either the tutor has selected to end the session at 952 or the student has selected to end the session at 962, the system application requests verification at 954. If the end session request is verified at 956, the system application runs subroutine 958 to end the session, save the whiteboard pages, and record billing information for the session. If no verification is received, the process returns to the start of event loop 920. If the process determines that a disconnection has occurred at 974, the system application runs disconnection subroutine 976.

Typically, approvals and verification requests, such as at 936 and 954 in FIG. 9 will be performed by sending a pop-Lip dialog box to the interface of the appropriate party. Other selections, such as content loading at 922, 932, or page requests at 942, or session end requests at 952, 962, are typically preformed by selecting appropriate items or icons in a console portion of the tutor or student interfaces.

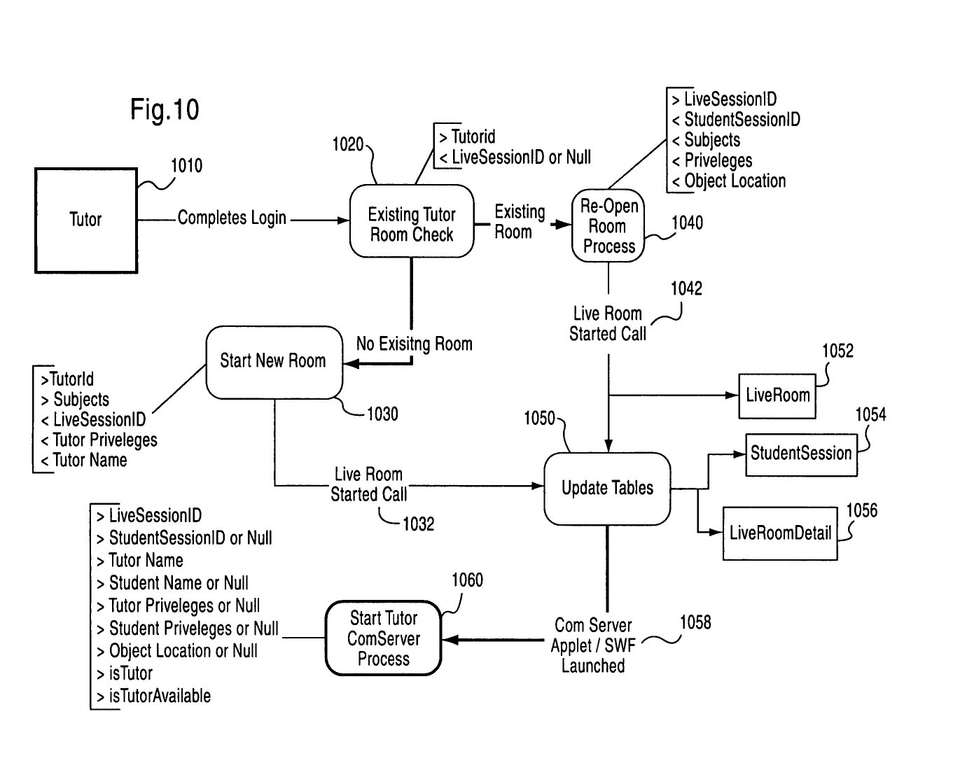

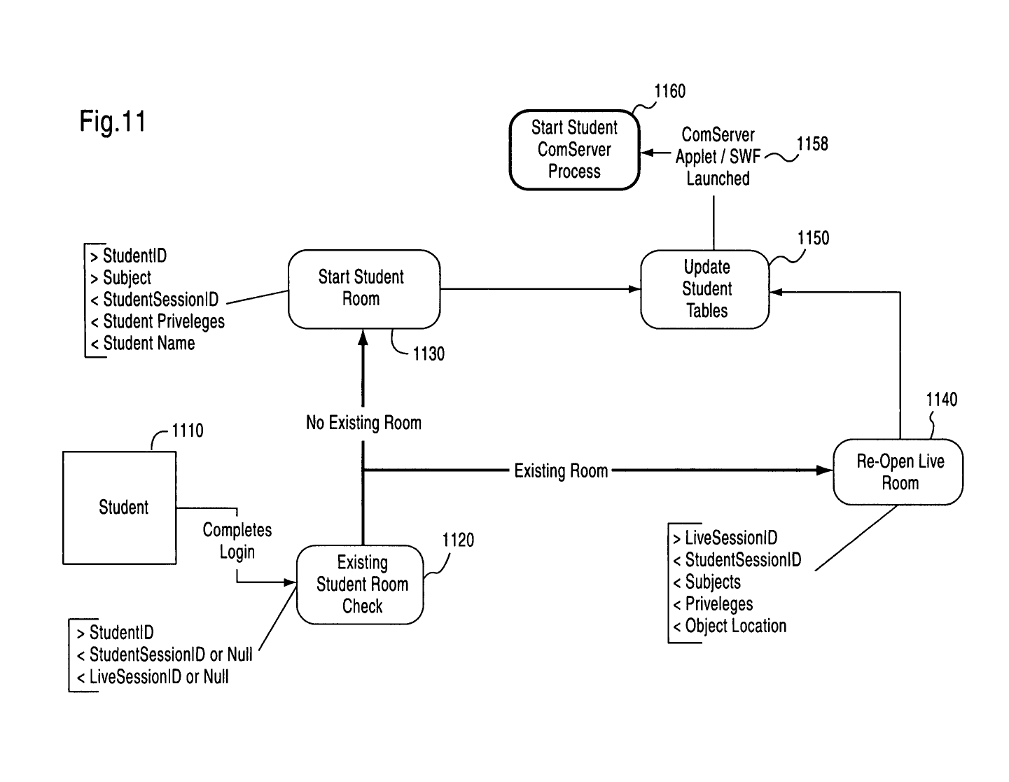

FIGS. 10 and 11 illustrate detailed flow charts for initiating a tutor server process and a student server process, respectively, for a whiteboard session according to an embodiment of the present invention. As illustrated in FIG. 10, after a tutor 1010 completes login, the system application performs existing tutor room check 1020 based on tutor ID input and outputs either a live session ID if an existing room is found or null if no existing room is found. If the output is null, the system starts a new room 1030 and inputs a tutor ID and subjects and outputs a live session ID, tutor privileges and tutor name. A live room started call 1032 is sent to the system application, which updates database tables at 1050, including student session table 1054 and live room detail table 1056.

If an existing room is found at 1020 (i.e., the check outputs a live session ID), a re-open room process 1040 is performed with the live session ID as the input and student session ID, subjects, privileges, and object location as the output. A live room started call 1042, which updates database tables at 1050, including live room table 1052, student session table 1054, and live room detail table 1056.

Whether from a new room or re-opened room, after the database tables are updated at 1050, a communication server applet is launched at 1058 and the tutor communication server process is started at 1060 with input from the database including: live session ID, student session ID, tutor name, student name, tutor privileges, student privileges, object location, information on tutor availability (times days).

As illustrated in FIG. 11, after a student 1110 completes login, the system application performs existing student room check 1120 based on student ID input and outputs either a live session ID and/or student session ID if an existing room is found or null if no existing room is found. If the output is null, the system starts a new room 1130 and inputs a student ID and subject and outputs a student session ID, student privileges and student name. The system application then updates student database tables at 1150.

If an existing room is found at 1120 (i.e., the check outputs a live session ID and or student session ID), a re-open live room process 1140 is performed with the live session ID as the input and student session ID, subjects, privileges, and object location as the output. The system application then updates student database tables at 1150. Whether from a new room or re-opened live room, after the database tables are updated at 1150, a communication server applet or SFW Flash movie is launched at 1158 and the student communication server process is started at 1160.

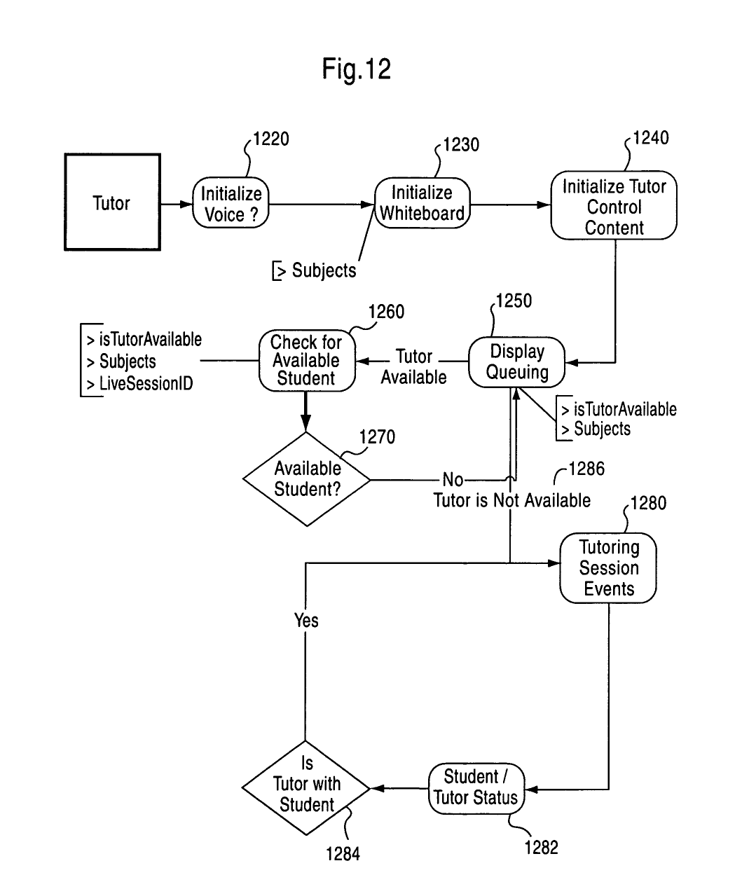

FIG. 12 illustrates a detailed flow chart for a tutor availability process according to an embodiment of the present invention. The tutor process of FIG. 12 initializes voice capabilities at 1220 if the option is selected and initializes the whiteboard at 1230. Subject information can be input as part of the initialization of the whiteboard so that buttons and other whiteboard options (or console options) can be customized to the particular subject. The process then initializes tutor control content at 1240.

The process then displays queuing at 1250 based on input of information regarding whether the tutor is available and the subjects. If a tutor is available, the system checks for an available student at 1260 based on input of information regarding whether the tutor is available, subjects, and live session ID. If there is no available student, the process returns to display queuing at 1250.

If the tutor is not available, the process enters a tutoring session events loop at 1280 that determines student and/or tutor status at 1282 to determine if the tutor is with a student at 1284. If so, the process returns to the start of the loop at 1280. While not illustrated, the system can also perform a check of the online status of the student so as to exit the loop when the student goes offline.

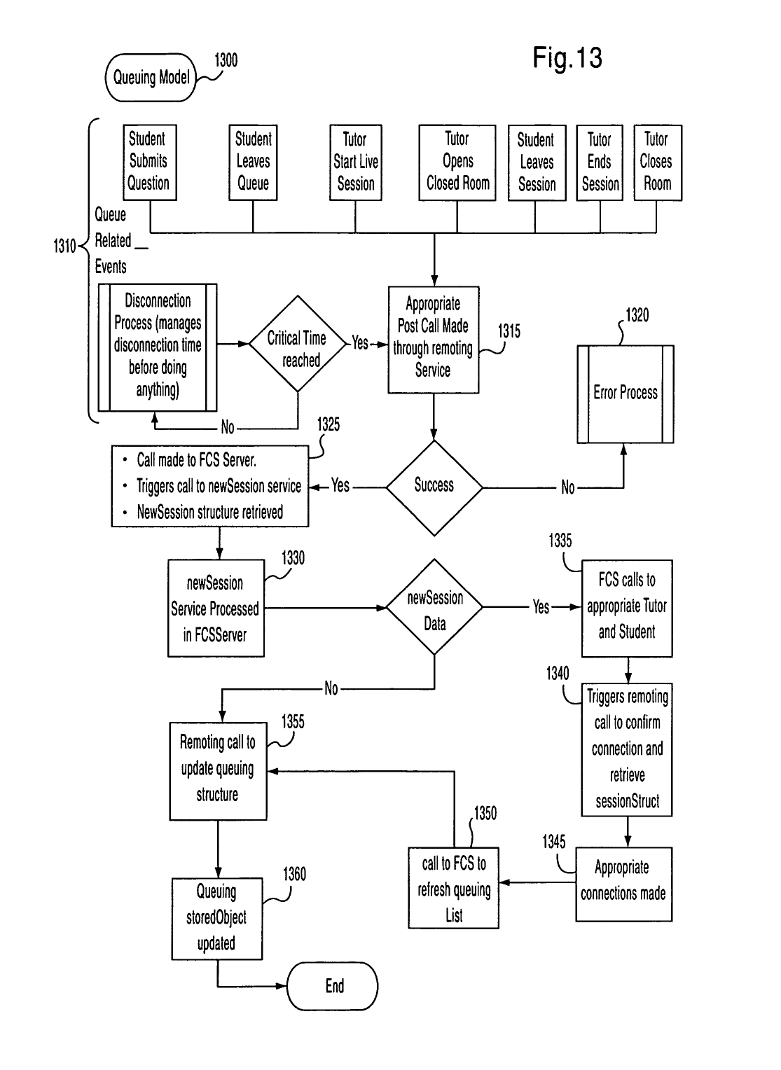

FIG. 13 illustrates an embodiment of a queuing model 1300. Queue-related events 1310 include various actions, such as a student submitting a question, a student leaving a queue, a tutor starting a live session, a tutor opening a closed room, a student leaving a session, a tutor ending a session, a tutor closing a room, and a disconnect timeout period being reaches. Each of these events makes an appropriate post call 1315 to the system. If the call is unsuccessful, an error process subroutine 1320 is invoked. If the call is successful, a call is made to the FCS server, the FCS server triggers a call to the newSession service to start a new session, and a newSession structure is retrieved at 1325. The newSession service is processed 1330 in the FCS server and looks for newSession data at 1332. If newSession data is found, the FCS server makes calls to the appropriate tutor and student at 1335, triggers a remoting call to confirm connections and retrieve session structure data (sessionStruct) at 1340, appropriate connection are made at 1345, a call is made to the FCS server to refresh the queuing list at 1350, and a remoting call is made to update the queuing structure at 1355 and the queuing storedObject is updated at 1360. If no newSession data is found at 1332, a remoting call is made to update the queuing structure at 1355 and the queuing storedObject is updated at 1360.

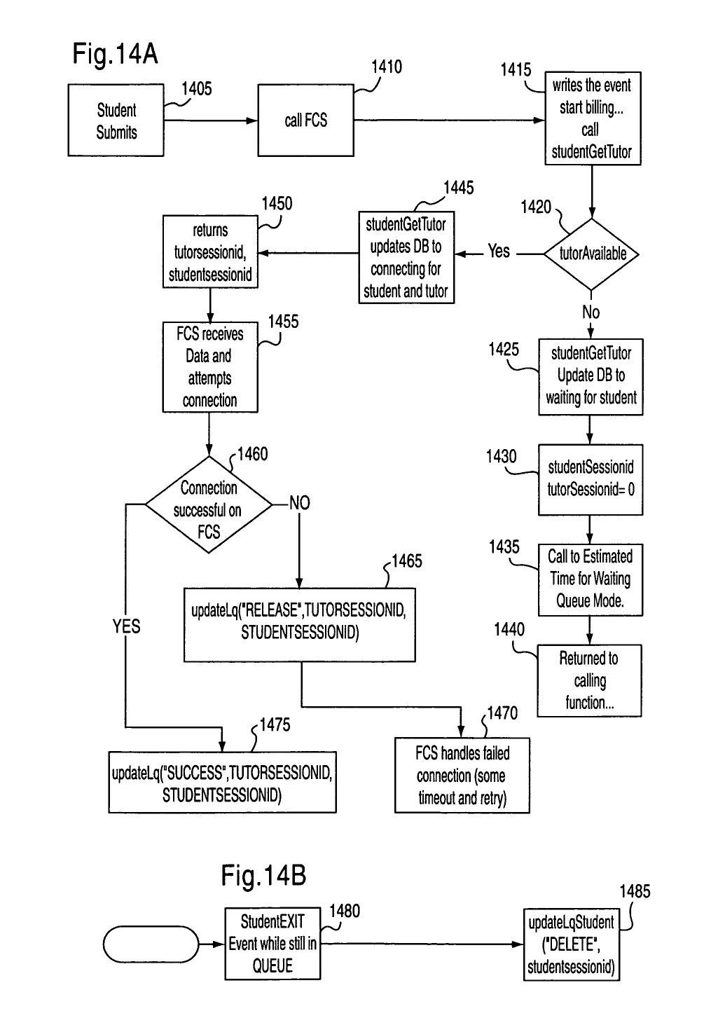

FIG. 14A and 14B illustrate student actions related to the queue in FIG. 14A, a student submits a question at 1405 to enter the queue, which calls the FCS server at 1410, that writes an event to start billing and makes a call for the student to gat a tutor (“studentGetTutor”) at 1415. The system checks to see if a tutor is available at 1420, and if no tutor is available the database is updated to indicate a student is waiting at 1425, the student session ID and tutor session ID are set to 0 at 1430, a call is made to get an estimated time for waiting in the queue at 1435, and the process is returned to the calling function at 1440.

If a tutor is available at 1420, the database is updated to the student and tutor are connecting at 1445 and returns a student session ID and tutor session ID at 1450. The FCS server receives the data and attempts the connection at 1455. If the connection is successful on the FCS server at 1460, the queue database is updated to indicate a successful connection with the student and tutor session IDs at 1475. If the connection is not successful on the FCS server at 1460, the queue database is updated to indicate release the connection with the student and tutor session IDs at 1465 and the FCS server handles the failed connection after some timeout and retries at 1470.

In addition to a student affecting the queue by submitting a question, as at 1405, a student can affect the queue by exiting the queue at 1480, as illustrated in FIG. 14B. Upon exiting the queue at 1480, the database is updated to delete the student and the student session ID from the queue at 1485.

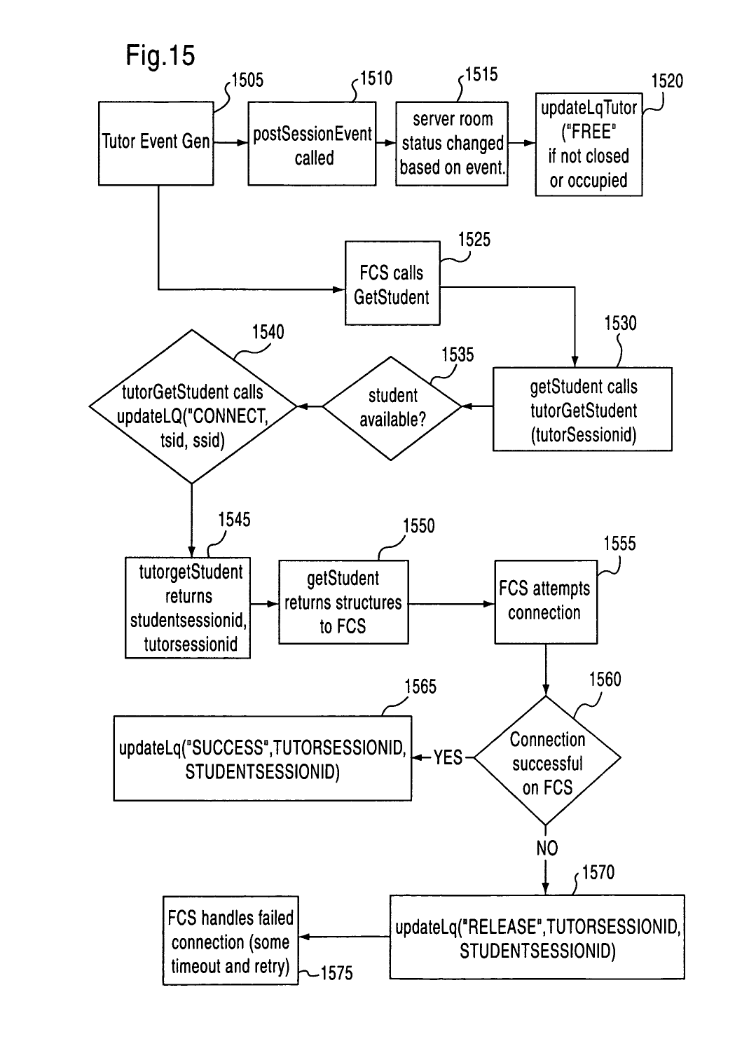

FIG. 15 illustrates how tutor generated events 1505 affect the queue. One such event is a post session event 1510 such as a tutor opening a closed room or ending a session without closing the room. Upon such an event, the server room status is changed at 1515 and the database is updated to show a free room at 1520. Another event generated by a tutor that affects the queue is a tutor starting a live session. In this case, the FCS server makes a GetStudent call at 1525, which makes a tutorGetStudent call with a tutor session ID at 1530. If a student is available at 1535, tutorGetStudent updates the database to connecting for the student and tutor at 1540 and returns student and tutor session IDs at 1545 to getStudent. GetStudent returns the data to the FCS server at 1550 with then attempts a connection at 1555. If the connection is successful at 1560, then the database is updated at 1565 to indicate the successful connection and the student and tutor IDs. If the connection is not successful on the FCS server at 1560, the queue database is updated to indicate release the connection with the student and tutor session IDs at 1570 and the FCS server handles the failed connection after some timeout and retries at 1575.

In use, the queuing module displays an estimated waiting time to students and displays the number of students in the queue by tutor subject to tutors. Logged-in coordinators can view various queue details, including a list of students in the queue by subject and actual waiting time. Coordinators can also view a list of sessions in progress, a current status of rooms by tutor, and a summary of room status. Indeed, in a manner similar to the student and tutor GUIs accessed by their home pages, coordinators also have a GUT viewer accessible by homepage.

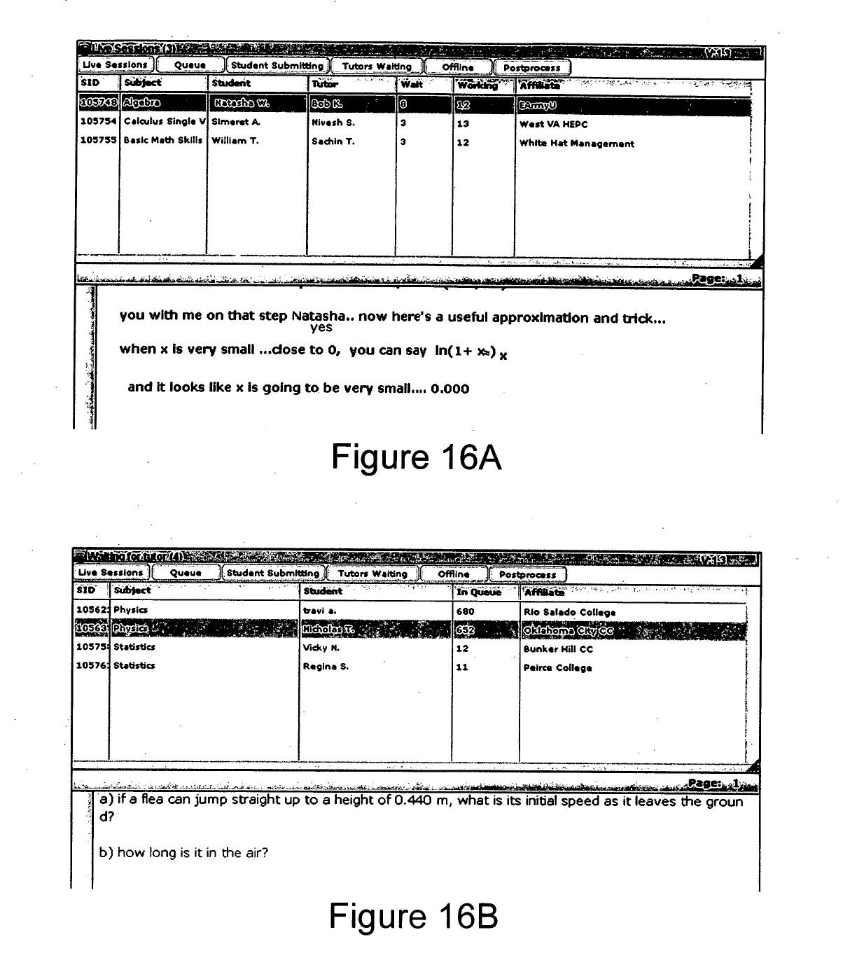

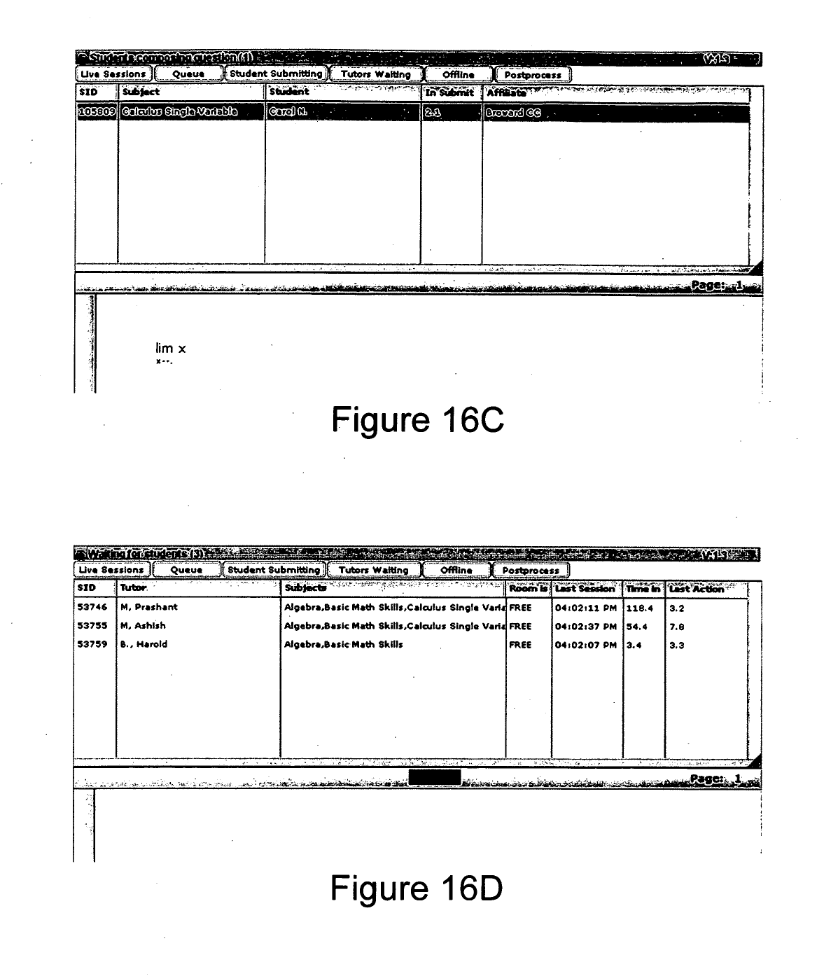

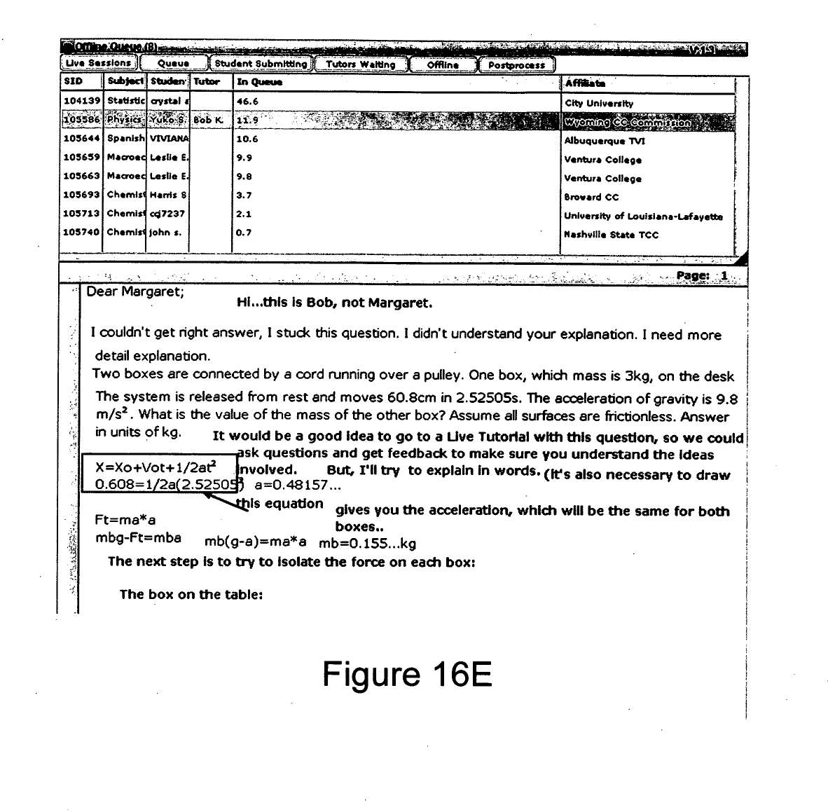

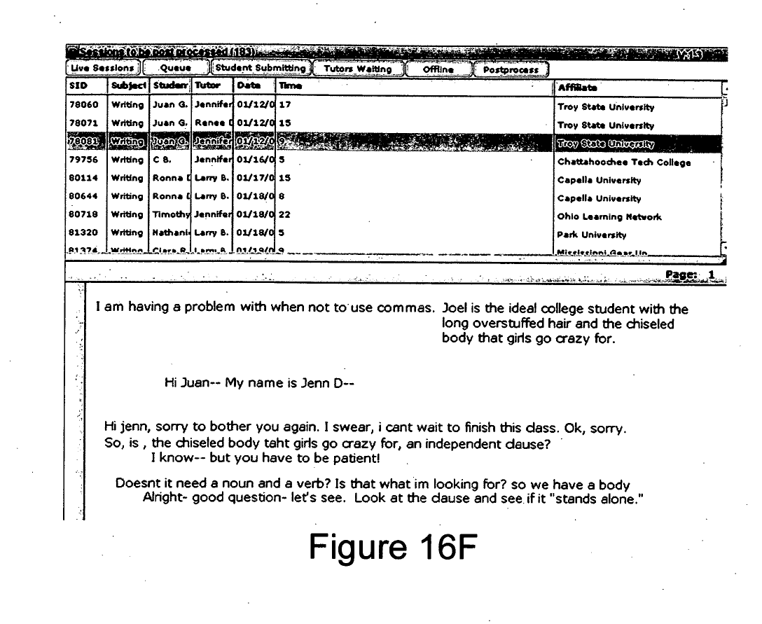

As illustrated in FIGS. 16A-F, a coordinator session viewer has links or buttons to switch between various views of system activity. In the “Live Session” view of FIG. 16A, the viewer shows session ID (SID), Subject, Student name, Tutor name, Wait time, Working time, and Affiliate institution for sessions that are in progress at the moment the screen is being displayed. By selecting a session ID row (or any other item in the row), the whiteboard for the selected live session is shown in a lower portion of the viewer. This view is useful for monitoring students and tutors during live sessions. As illustrated in FIG. 16A, an administrator/coordinator can actually see the interchange between the tutor and the student as it is occurring.

In the “Queue” view of FIG. 16B, the administrator/coordinator is able to see the student who are waiting for tutors. The viewer shows SID, Subject, Student name, time In Queue, and Affiliate institution. By selecting a session ID row (or any other item in the row), the whiteboard with the selected student's submitted question for starting a session is shown in a lower portion of the viewer. This view is useful for monitoring the size of the queue and the wait times per subject. It is also useful for monitoring what sorts of questions are being submitted by students.

In the “Student Submitting” view of FIG. 16C a user is shown those students who are in the process of submitting a question to the system. The viewer shows SID, Subject, Student name, time In Submit mode, and Affiliate institution. By selecting a session ID row (or any other item in the row), the whiteboard for the selected offline question submission session is shown in a lower portion of the viewer. This view is useful for monitoring how many students are submitting questions offline and how long it takes for students to submit questions.

In the “Tutors Waiting” view of FIG. 16D a user is shown the available tutors and their respective subject areas of expertise. These are tutors who are available but for whom no session is active. The viewer shows session ID (SID), Tutor name, Subjects, Room status, time of Last Session, Time In, and Last Action. This view is useful for monitoring the number of open rooms per subject and the time and efficiency of tutors.

In the “Offline” view of FIG. 16E a user is shown those students who have submitted questions in specific subject matter areas for response from a tutor via an offline response. The viewer shows session ID (SID), Subject, Student name, Tutor name, time the question has been In Queue, and Affiliate institution. By selecting a session ID row (or any other item in the row), the whiteboard for that question is shown in a lower portion of the viewer. This view is useful for monitoring what sort of questions are being submitted offline and how long questions are remaining in the queue by subject area.

In the “Postprocess” view of FIG. 16F a user is shown those sessions that are being post processed for archival and related purposes. The viewer shows session ID (SID), Subject, Student name, Tutor name, Date, Time of the session, and Affiliate institution. By selecting a session ID row (or any other item in the row), the archived whiteboard for that session is shown in a lower portion of the viewer. This view is useful for monitoring both students and tutors by viewing archived sessions.

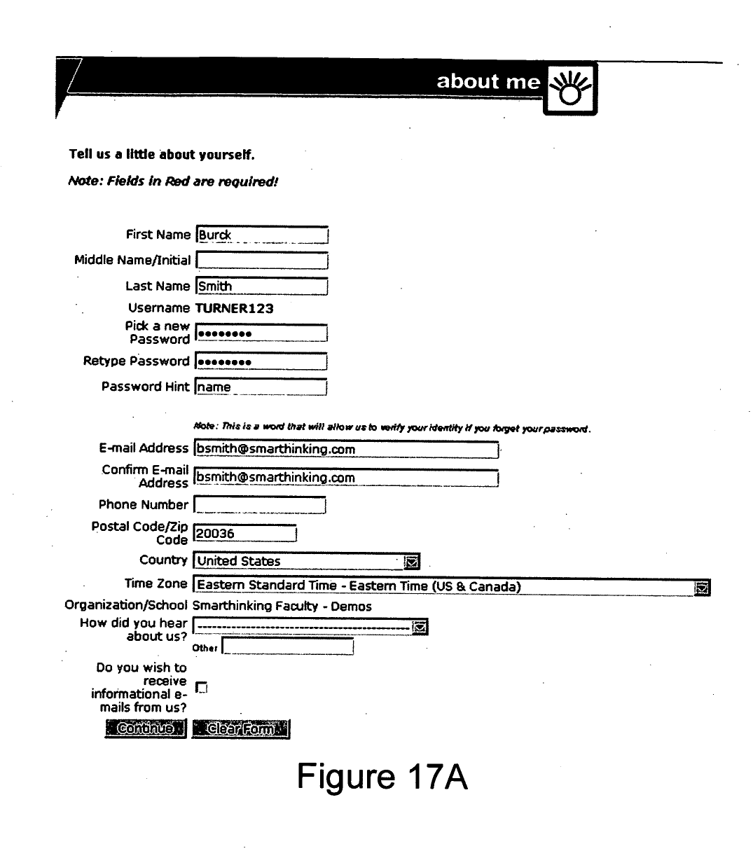

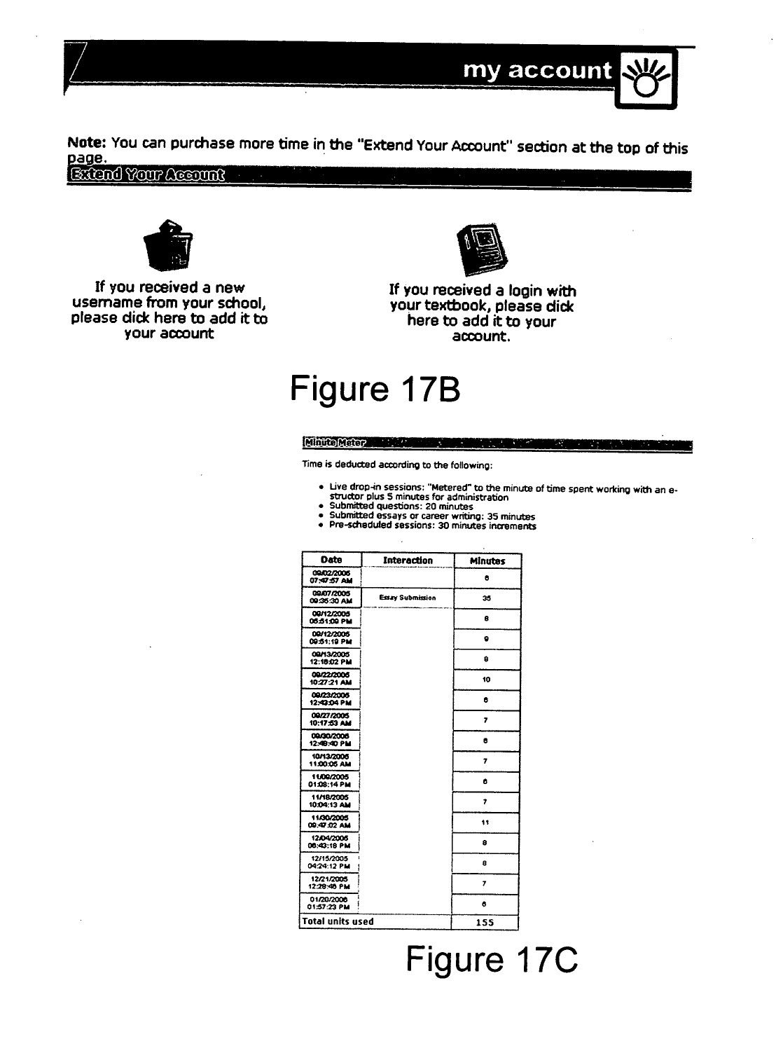

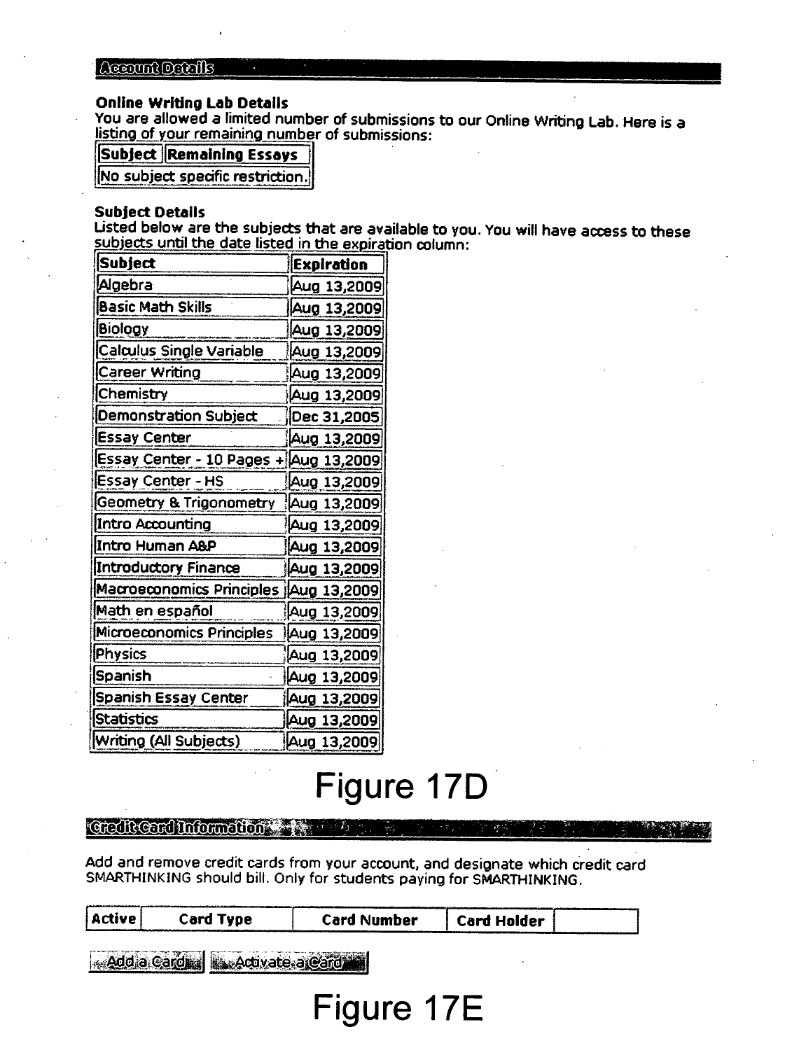

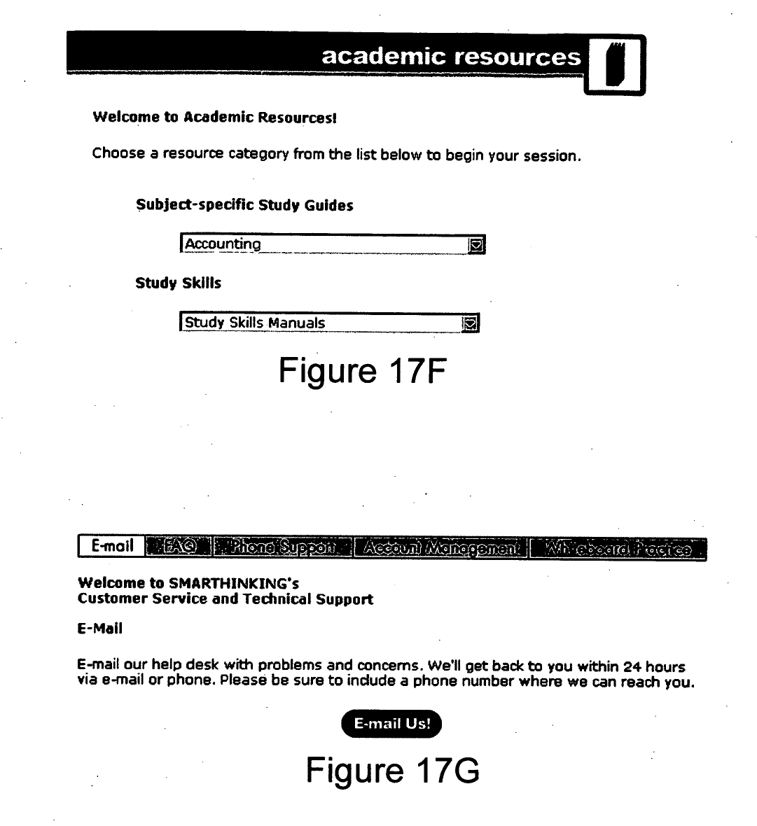

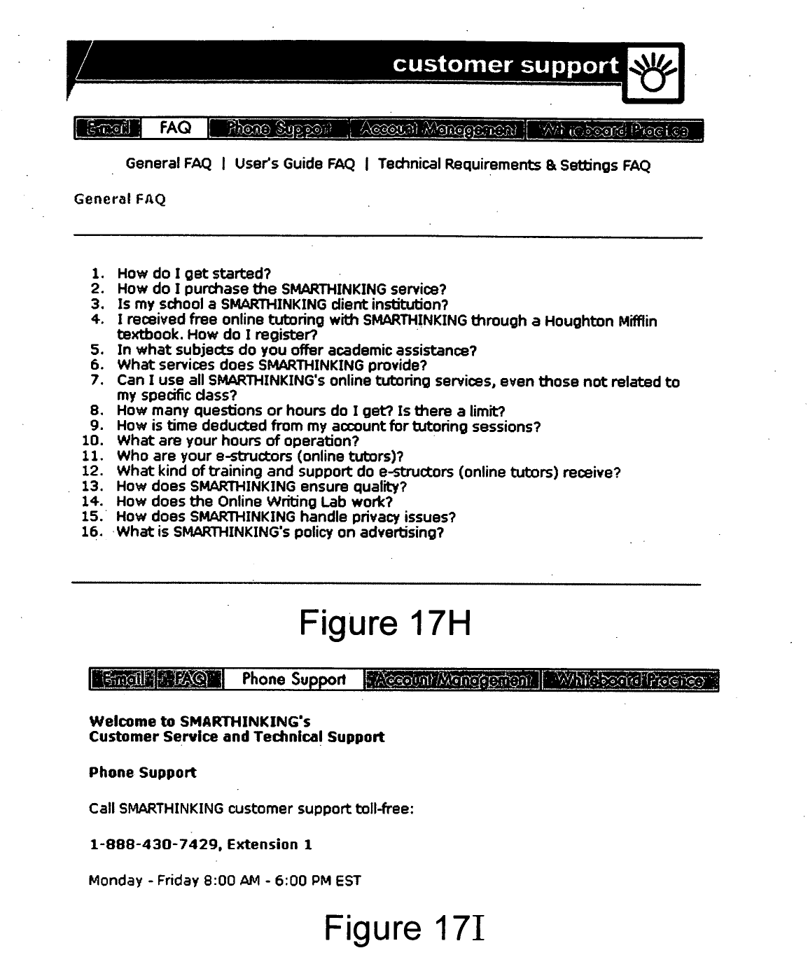

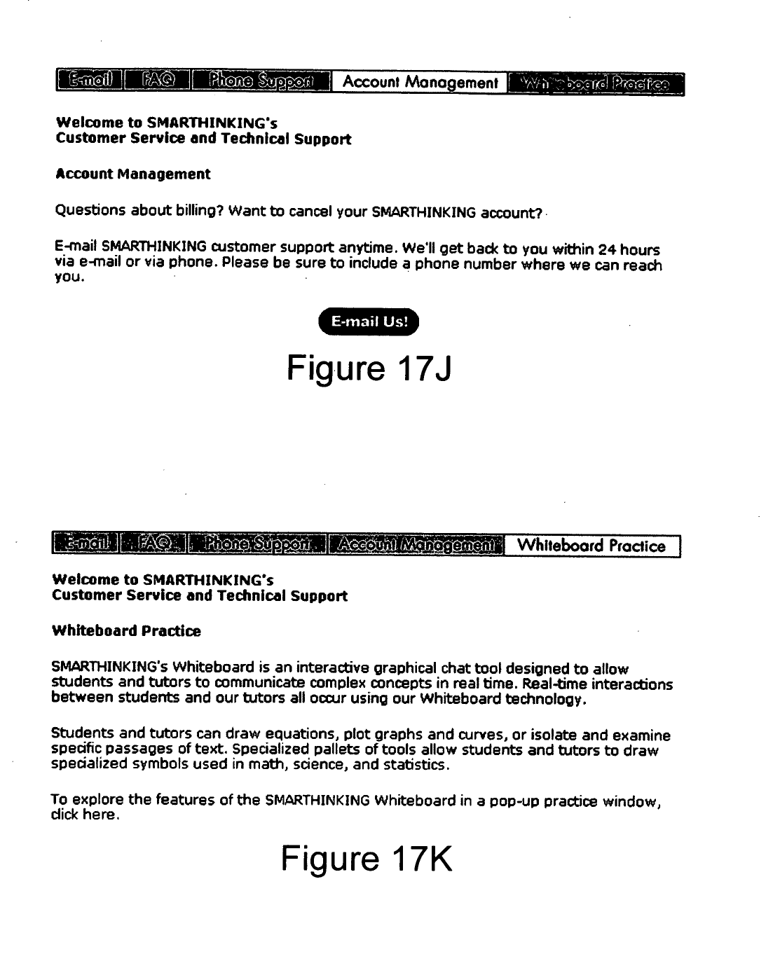

The student homepage discussed in FIG. 4A links to additional pages within the student GUI. Upon selecting a link from the left side of the page, the student is presented with additional pages. FIG. 17A illustrates an embodiment of a page presented to a student upon selecting the “about me” link on the left side of FIG. 4A. The “about me” page includes a form for providing/editing the student's name, user name, password, contact information, affiliation, etc.

Upon selecting the “my account” link on the left side of FIG. 4A, the student is taken to a “my account” page with details of their student account. As illustrated in FIG. 17B, one portion of the “my account” page relates to extension of the student account and has links for adding user names provided by schools/institutions or logins provided with textbooks. This allows a student to use the system of the present invention when a particular school purchases a block of time for its students. The school can assign a password to the student that will then be accepted by the system of the present invention. Alternatively, a password may have been associated with a textbook the student has received. In that case, the specific password can be used allowing tracking of the sources of the questions being asked. Another portion of the “my account” page has a “minute meter” for tracking the number of minutes the student has used from their account, as illustrated in FIG. 17C. The “my account” page further includes a portion displaying account details related to the number of allowed submissions to (in this case) the online writing lab and the available tutoring subjects and expiration dates, as illustrated in FIG. 17D. A final portion of the “my account” page contains credit card information for students that pay for services, as shown in FIG. 17E.

Upon selecting the “academic resources” link on the left side of FIG. 4A, the student is taken to a page that allows the student to choose resources from pull-down menus to begin sessions with subject-specific study guides and study skills manuals, as shown in FIG. 17F. Similarly, upon selecting the “cust. support & faq” link on the left side of FIG. 4A, the student is taken to a page that allows the student to choose tabs linking to email support, as shown in FIG. 17G, frequently asked questions, as shown in FIG. 17H, telephone support, as shown in FIG. 17I, account management customer support, as shown in FIG. 17J, and whiteboard practice, as shown in FIG. 17K.

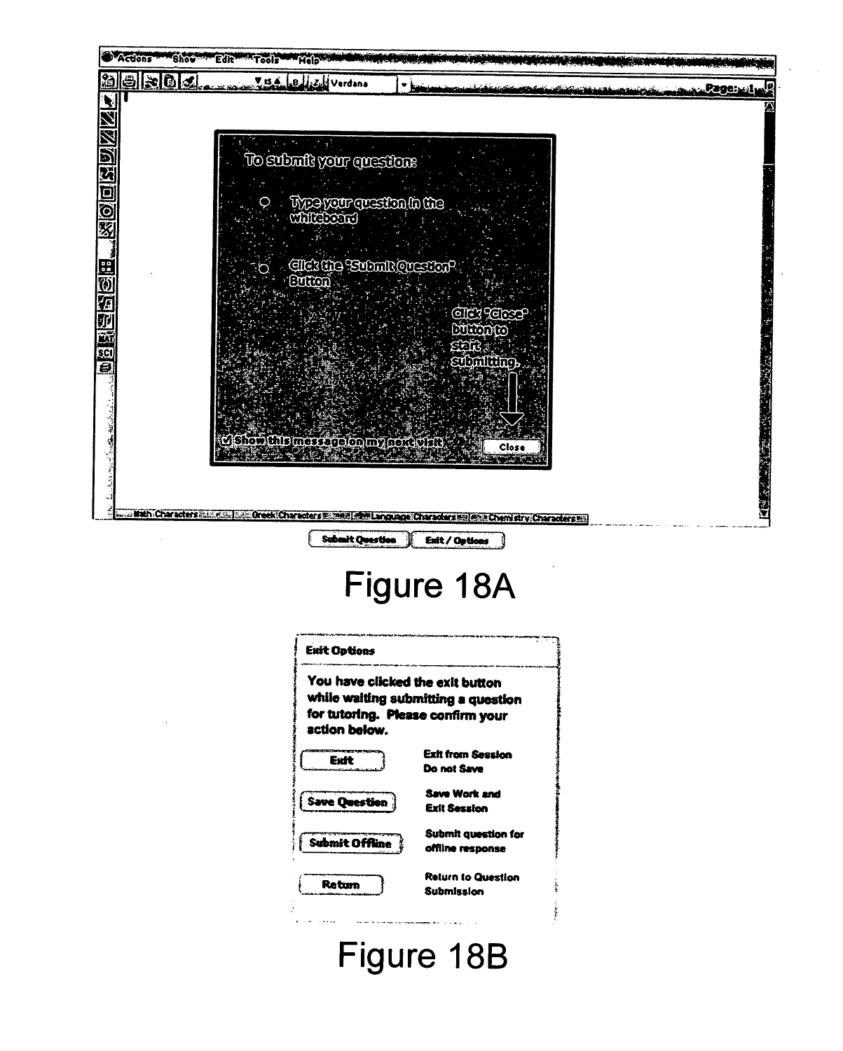

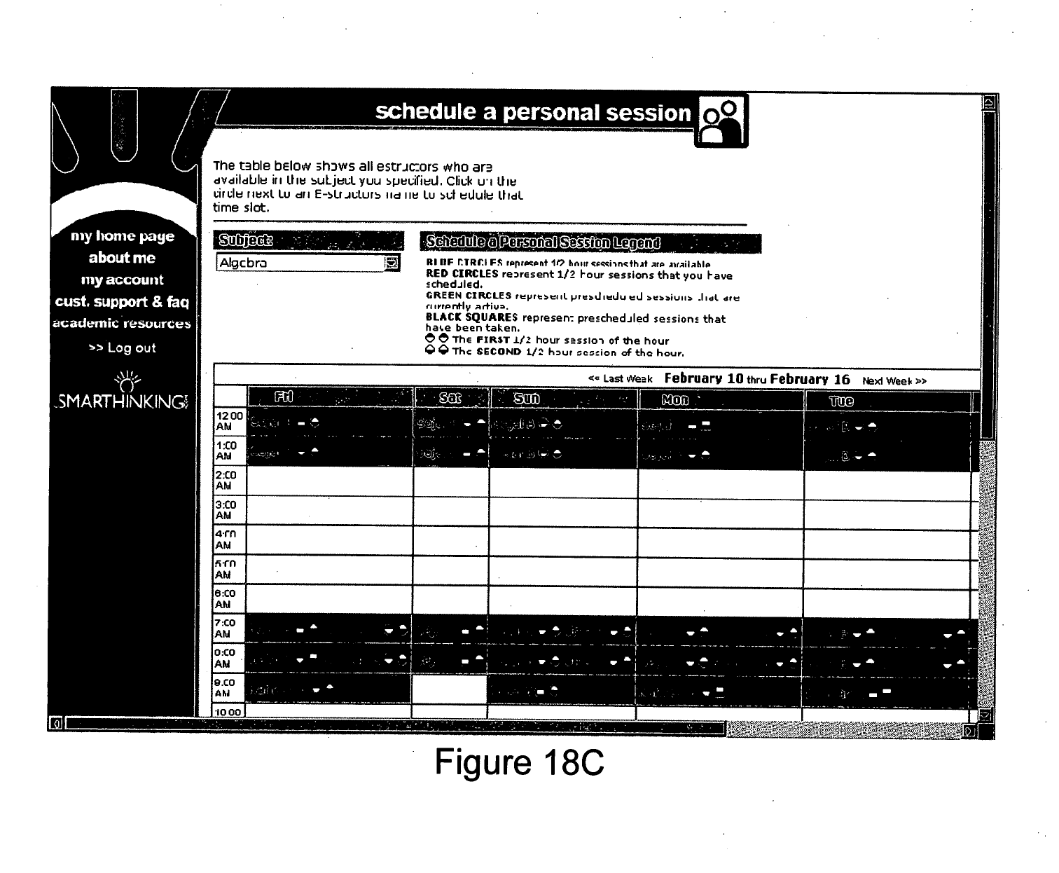

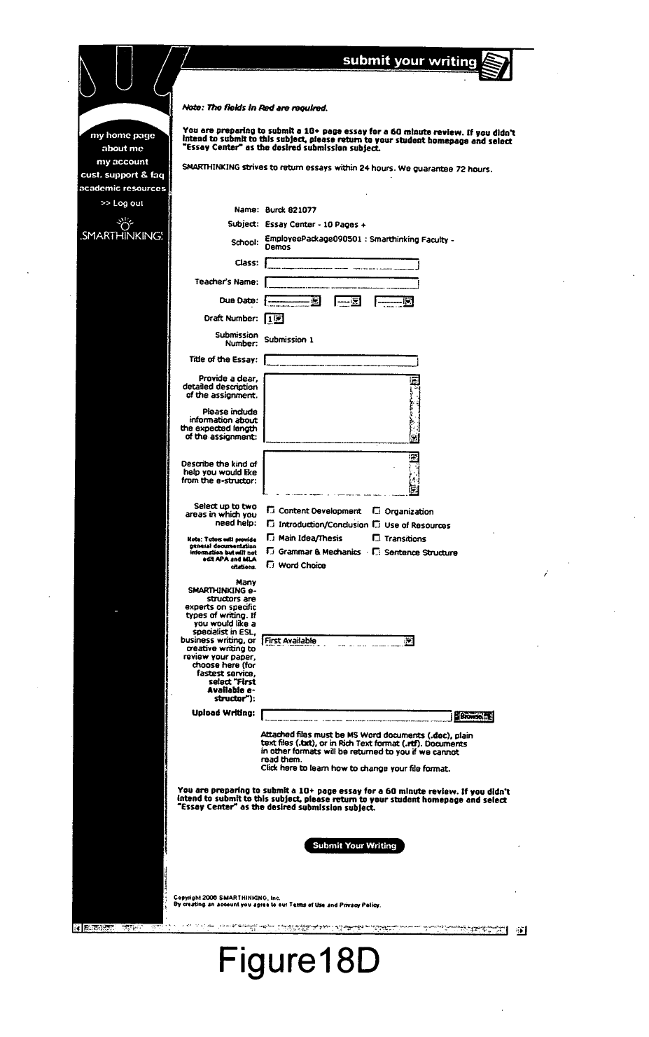

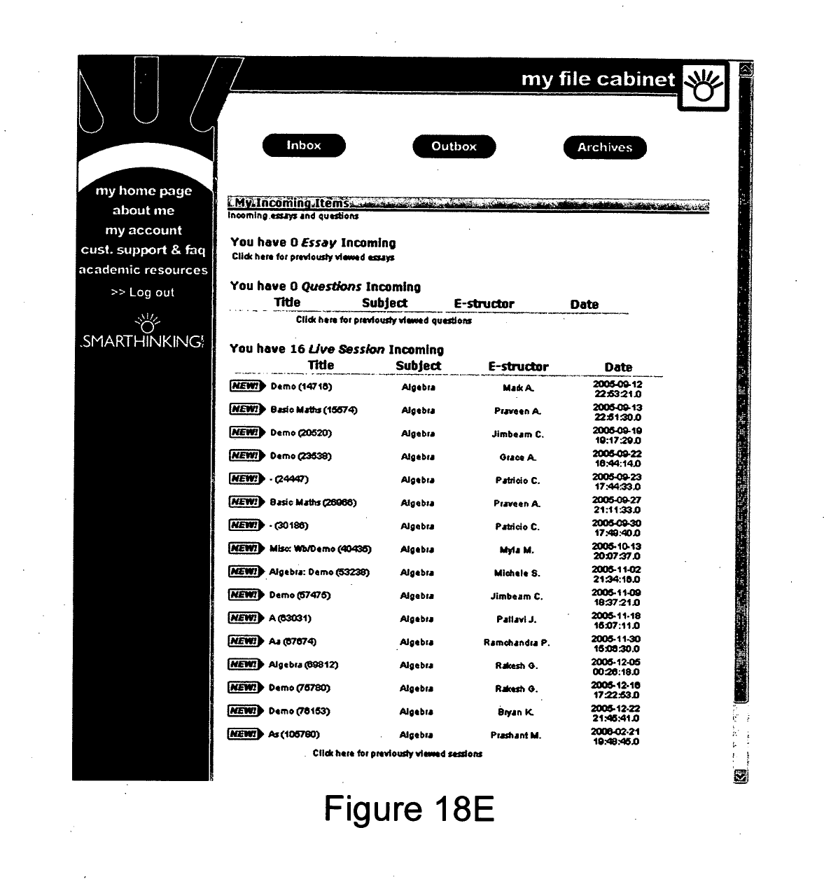

When a student wants to connect with a tutor for a live session, the student selects a subject from the pull-down menu adjacent the “connect with an e-structor now!” icon and text of FIG. 4B to open a whiteboard in the appropriate subject. As illustrated in FIG. 18A, the whiteboard opens and comprises a window instructing the student to type the question in the whiteboard and to then click the “submit question” button. Upon submitting the question, the student enters the live queue and waits for a tutor with appropriate expertise. Further, as illustrated earlier, that student's information and place in the queue is available to system administrators/coordinators. If the student instead wishes to exit the whiteboard, the student is presented with various options to allow the student to exit the session without saving any work, exit and save work, exit and submit the question offline, or return to the question submission, as illustrated in FIG. 18B. The exact exit options or privileges of a student can be controlled by XML files and can be customized based on the student's Affiliate institution and/or the specific subject being tutored.

In an alternate embodiment, a software module, script, or applet can be provided on a student's computer that allows the student to reach the whiteboard of FIG. 18A in an appropriate subject without the need to log into a homepage first. In this embodiment, all login and authentication information is stored and passed transparently to the system when the student launches the software, thus allowing the student to “bypass” the student home page and go straight to tutoring. Similarly, a software module, script, or applet can be provided on a students' desktop or a school's webpage that alert students to wait times and tutor availability. Indeed, virtually any of the functionality of the student homepage can be provided in a separate manner on a student desktop or school homepage without departing from the scope of the invention.

When a student wants to schedule a personal session, the student selects a subject from the pull-down menu adjacent the “schedule a personal session” icon and text of FIG. 4D to open a weekly schedule of available tutor times for the selected subject, as illustrated in FIG. 18C. The schedule has links for moving to other weeks and a pull-down menu for switching subjects. In this illustration, the student can select a specific tutor with whom to schedule a session. This is then communicated to the tutor who can then be available at the appointed time and date.

When a student wants to submit writing, the student selects the appropriate subject or type of submission from the pull-down menu adjacent the “submit your writing” icon and text of FIG. 4C and is presented with an appropriate form submission page. For example, if the student chose to submit a 10+ page essay for 60 minute review from the pull-down, a form submission page adapted to this subject is presented to the student, as illustrated in FIG. 18D. The student fills in the form that permits the student to identify the assignment for which the writing is being submitted to the tutor. The student may also request the type of help desired such as punctuation, stricture etc. The student then attaches required files (e.g., a text, rich text, or Microsoft Word document file that contains the submitted writing), and clicks the submit button to send the request. Each type of writing submission preferably has its own appropriate form for submission, although this is not a requirement since a single form can be adapted for multiple types of submissions.

When a student wants to submit a question, they select the subject from the pull-down menu adjacent the “submit a question” icon and text of FIG. 4D, open a whiteboard in a manner similar to that discussed for a live session, enter the question to be answered offline in the whiteboard, and select to submit the question offline by selecting the appropriate button in the whiteboard.

When a student selects the “my file cabinet” link from the lower portion of the student homepage illustrated in FIG. 4A, a “my file cabinet” page is opened as illustrated in FIG. 18E. This page comprises links to any incoming essays (i.e., critiqued essays), incoming questions (i.e., answers to submitted questions), and incoming live sessions (i.e., sessions that have been post processed and archived). These are identified by the subject matter and the instructor providing assistance.

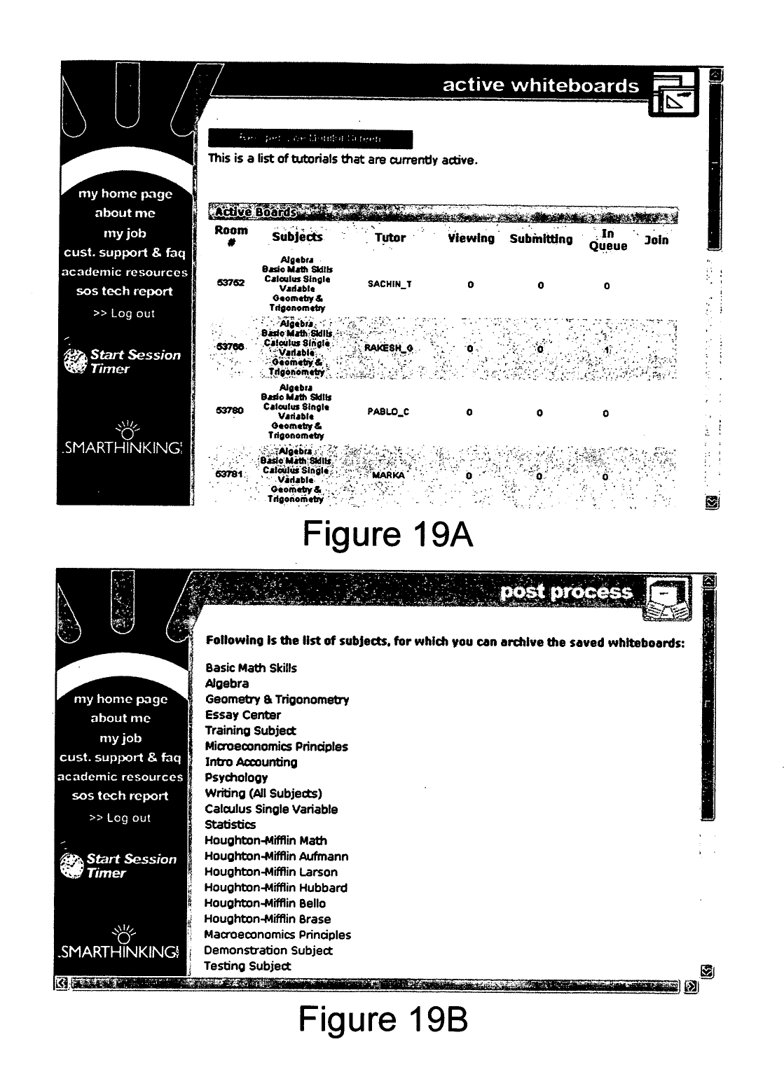

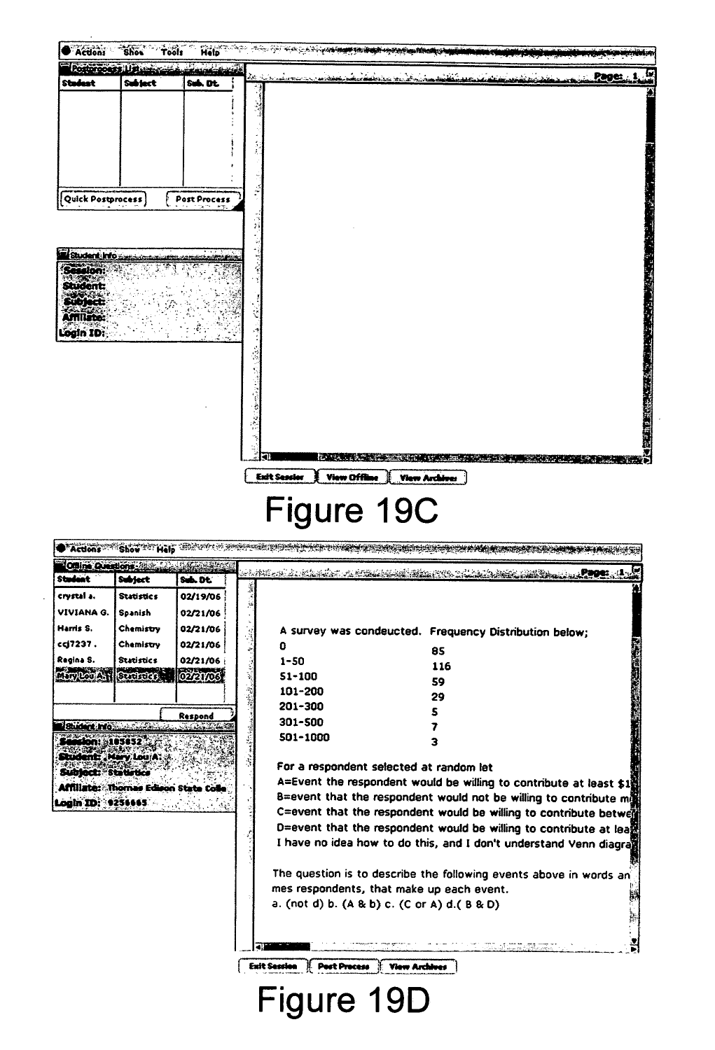

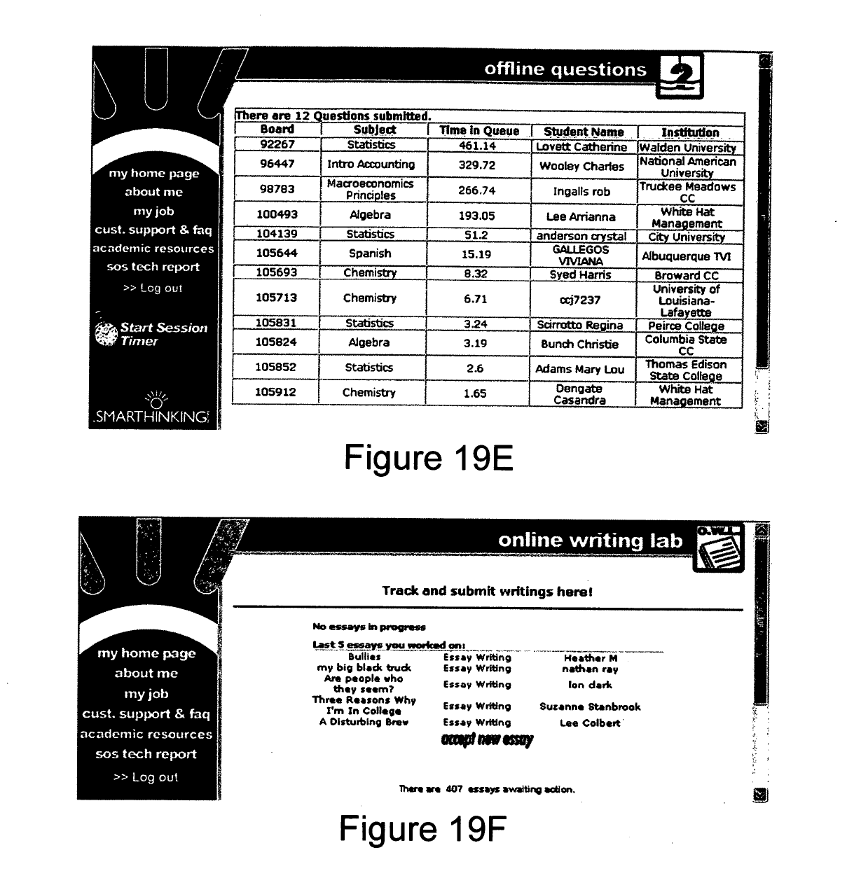

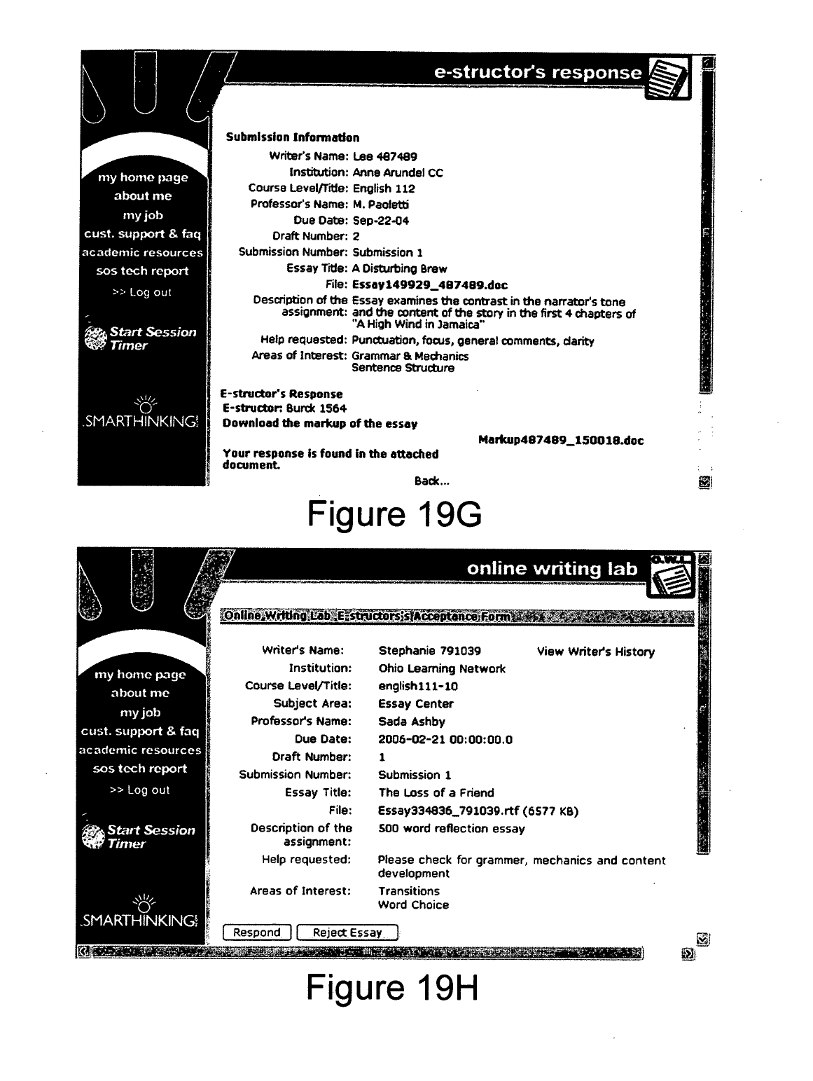

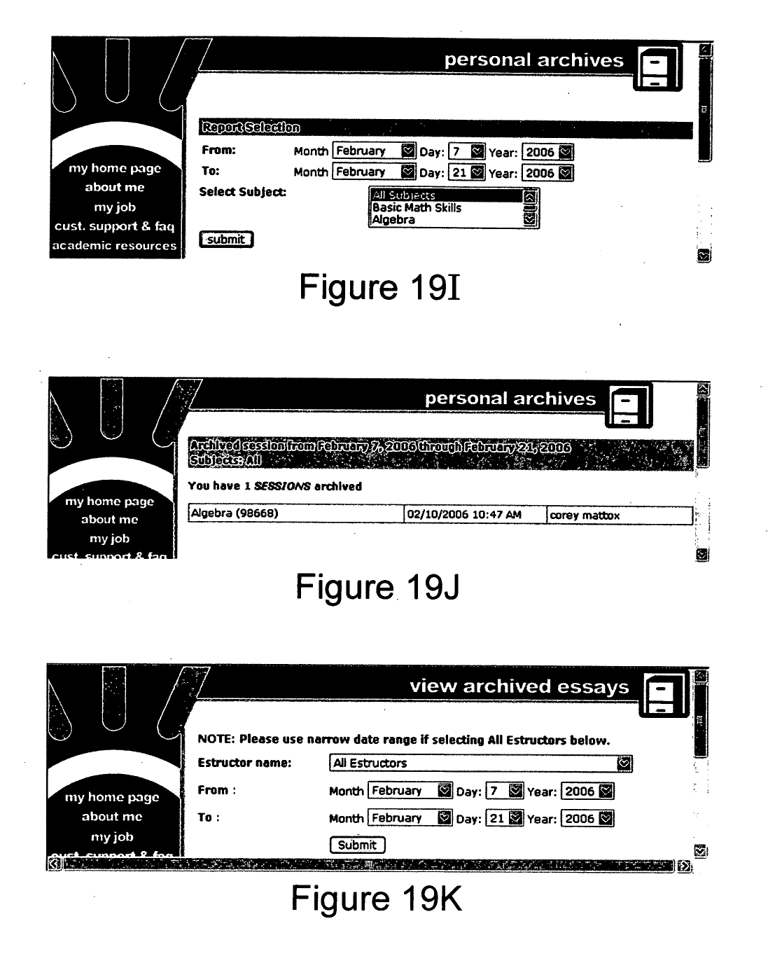

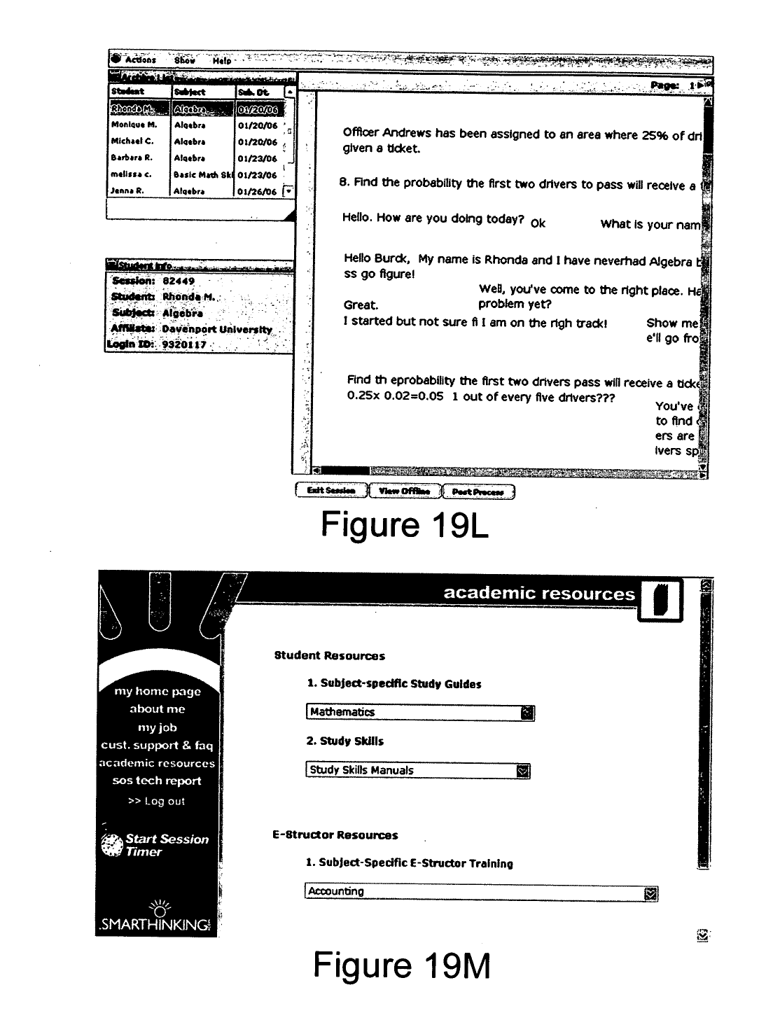

The tutor homepage of FIG. 5A links to numerous other tutor pages. Upon the tutor selecting to view active whiteboards by selecting or clicking the “active whiteboards” icon, an active whiteboards page, as illustrated in FIG. 19A, is displayed to inform the tutor as to what other tutors and subject sessions are open. Upon choosing to post process by selecting or clicking the “post process” icon in FIG. 5A, a post process page as shown in FIG. 19B is displayed to show what subjects the tutor can archive saved whiteboards. The tutor can then select a subject and view the saved whiteboards that the tutor can post process and archive as illustrated in FIG. 19C.

While the post process list in the upper left portion of FIG. 19C is empty, the screen illustrates the tools of post processing. If a saved whiteboard does not need any editing or correction, the tutor can choose to “Quick Postprocess” by selecting that option. Otherwise, the selected session is displayed for the tutor to clean up for archiving. Upon being ready to archive, the tutor selects “Post Process” to archive the whiteboard session. The tutor can also choose to exit the session, view offline questions, or view archived session using buttons at the bottom of FIG. 19C. If the tutor chooses to view offline questions from this screen, an offline question list appears in place of the post process list and a post process button takes the place of the offline question button, as illustrated in FIG. 19D. If viewing offline questions is selected from the main homepage of FIG. 5A, an offline question page as shown in FIG. 19E is displayed, and upon selection of a question, a page such as FIG. 19D is displayed that comprises the student question in the whiteboard portion, a portion with some of the student's information (i.e., session, name, subject, affiliate institution, and login ID), and a “respond” button for the tutor to select in order to respond to the question. FIG. 19E illustrates the information available to the tutor for an offline response to questions. For example the subject matter and time the student has been waiting for a response is displayed. The tutor can select a question to which to respond accordingly.

The tutor can also select to view their online writing lab page from the by choosing the “online writing lab” icon from the homepage. The tutor's online writing lab page is illustrated in FIG. 19F and displays essays in progress, recent essays worked on, the number of essays awaiting action, and a link or icon to accept a new essay. Selecting a recent essay displays a page with details of the essay and a link to the document file, as shown in FIG. 19G. If the tutor chooses to accept a new essay, an essay acceptance/rejection page is displayed, as shown in FIG. 19H, to allow the tutor the opportunity to review details such as the assignment's due date, a description of the assignment, the draft number of the Submission, the particular type of help requested, and the areas of interest. The tutor can then decide whether take on the work or look for another essay to accept.

A tutor can also choose to view archives from their home page. Upon selecting a choice from the pull-down menu, the tutor is presented with a search page such as those of FIGS. 19I or 19K, with results displayed on another page with a link to the results, such as shown in FIG. 19J, that include the archive subject, date & time, and student name. When an archive is selected for viewing, as illustrated in FIG. 19L, the saved whiteboard is displayed. The tutor can view student information and can select other archives for viewing from the archive list window.

By selecting the “academic resources” icon of FIG. 5A, an academic resources page similar to the one available to students (FIG. 17F) is displayed to the tutor, as illustrated in FIG. 19M. In addition to the student resources previously discussed, the academic resources page for tutors comprises tutor resources such as subject specific instructor training materials that can be chosen from a pull-down menu.

In a typical usage of the present system, a tutor will be trained and approved for instructing students in a subject. The tutor will then logon to his/her homepage and schedule hours that they will be available to teach the subject so that students can schedule tutoring sessions with them. In addition to the scheduled hours, tutors can make themselves available on an ad hoc basis. In either situation, the tutor will open a whiteboard session so as to make a tutoring room available. When the session has been previously scheduled, the scheduled student will be able to join the tutor in the room. In the case of an ad hoc session or when a scheduled session has ended early, the tutor can make the room open to all students.

When a tutor is nearing the end of a session of scheduled availability and does not wish to take on additional students so as to avoid having to extend their work hours or cut a session short, the tutor can “close” a room to additional students in that period near the end of a scheduled session. During an ad hoc session, the tutor can close the room at any time.

Tutors are also responsible for post processing saved whiteboard sessions to place them in a condition suitable for archiving. During post processing, the tutor can add additional comments for the student or correct any errors that occurred during the session. In this manner, the archived whiteboard sessions can become a valuable resource to both students and tutors. A tutor can post process prior sessions while they are waiting for students to join an open room as well as post process sessions during times when they do not have a room open to students. Similarly, a tutor can answer offline questions while they are waiting for students to join an open rooms as well as answer offline questions during times when they do not have a room open to students. If a tutor begins work on an offline question but then decides he/she cannot answer the question, the tutor can choose to exit and select an option to return the question to the queue.

Tutors use a session timer to track their time they provide tutoring services so that they can be compensated. The session timers also assist in tracking the session time used by students.

In one embodiment, the invention is drawn to a system for providing tutoring services to one or more users that comprises a network, a tutoring application server connected to the network, one or more student interfaces connected to the tutoring application server over the network, and one or more tutoring interfaces connected to the tutoring application server over the network. The tutoring application server comprises a central processing unit, memory, operating system software, queuing module software for providing graphical user interfaces (GUIs) for students and tutors, wherein the queuing module software matches an available tutor to a student with a highest priority, and tutoring module software for providing GUIs for users and tutors, wherein the tutoring module software including whiteboard module software for providing a common template that both a tutor and a student can use to write and draw to interact with one another.

Variations of this embodiment include systems where the queuing module includes an algorithm that matches an available tutor to a student with a highest priority, the algorithm comprising: an assigned Affiliate Threshold (AT) that reflects a priority for an affiliate institution that uses the system, an assigned Subject Weight (SW) for each subject taught by a tutor, wherein the SW reflects the proficiency of the tutor in the subject, instructions for calculating a Threshold Capacity (TC) for each student in a queue seeking assistance in a certain subject when a tutor for the subject becomes available, wherein TC is calculated by summing an AT of each student with a SW of the tutor in the subject, instructions for calculating a Waiting Threshold (WT) for each of the students in the queue by dividing a time in queue for each of the students by the calculated TC, and instructions for calculating a Student Priority (SP) for each of the students by dividing the TC of each of the students by the SW of the tutor in the certain subject, wherein a student with a highest SP is determined to have the highest priority.

The system's tutoring module software interface for a tutor can include interface elements to allow the tutor to switch between a plurality of tutoring duties, wherein said interface elements can be icons, hypertext links, menus, and combinations thereof, and wherein the plurality of duties can be synchronous tutoring sessions, asynchronous tutoring sessions, annotation of previously-saved tutoring sessions, and transfer of a tutoring request to another tutor. The tutoring module software interface for a student can include a display of an estimated wait time and can include software to view stored content, such as documents, movies, audio, and combinations thereof, while waiting for a tutor. The tutoring module software can also include instructions and interface elements to allow students and tutors to import external content into the common template. Multiple content images may be imported, each of which can be moved anywhere within the tutoring template and proportionately resized as necessary. Full annotation capability is available in each content “window.”

In another embodiment, the invention is drawn to a method for providing a tutoring service over a network that comprises providing a tutoring application server on the network, serving one or more student interfaces over the network, and serving one or more tutoring interfaces over the network. In this method, the tutoring application server matches an available tutor in a subject to a student seeking assistance in the subject with a highest priority and provides a common template that both a matched tutor and student can use to write and draw to interact with one another. Many variations can be made to the method. In one variation, the tutoring application server matches the tutor and student with a queuing module and provides the common template with a tutoring module.

Another variation of the method comprises matching an available tutor to a student with a highest priority by: assigning an Affiliate Threshold (AT) that reflects a priority for an affiliate institution that uses the system, assigning a Subject Weight (SW) for each subject taught by a tutor, wherein the SW reflects the proficiency of the tutor in the subject, calculating a Threshold Capacity (TC) for each student in a queue seeking assistance in a certain subject when a tutor for the subject becomes available, wherein TC is calculated by summing an AT of each student with a SW of the tutor in the subject, calculating a Waiting Threshold (WT) for each of the students in the queue by dividing a time in queue for each of the students by the calculated TC, and calculating a Student Priority (SP) for each of the students by dividing the TC of each of the students by the SW of the tutor in the certain subject, wherein a student with a highest SP is determined to have the highest priority.

The method can also provide interface elements to allow the tutor to switch between a plurality of tutoring duties, where the interface elements can be icons, hypertext links, menus, and combinations thereof, and where the plurality of duties can include synchronous tutoring sessions, asynchronous tutoring sessions, annotation of previously-saved tutoring sessions, and transfer of a tutoring request to another tutor. Further variations of the method can display an estimated wait time to each student and allow students to view stored content, such as documents, movies, audio, and combinations thereof, while waiting for a tutor. Yet another variation of the method allows students and tutors to import external content into the common template.

The method can further include: having the student seek assistance in the subject by posting a question to the system and allowing the student to exit the queue and request an asynchronous response from a tutor, having the interaction on the common template saved for review by the tutor, the student, and an Affiliate, and having the saved interaction post processed by the tutor to make corrections or add comments.

It should also be understood that the system in accordance with the invention can accommodate multiple students being instructed together by a tutor during a single tutoring session.

The foregoing description of the preferred embodiments of the invention has been presented for the purposes of illustration and description. It is not intended to be exhaustive or to limit the invention to the precise form disclosed. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

1. A system for providing tutoring services to one or more users, comprising:
a network;
a tutoring application server connected to the network;
one or more student interfaces connected to the tutoring application server over the network;
one or more tutoring interfaces connected to the tutoring application server over the network;
wherein the tutoring application server comprises:
a central processing unit;
memory;
operating system software;
queuing module software for providing graphical user interfaces (GUIs) for students and tutors, wherein the queuing module software matches an available tutor to a student with a highest priority;
tutoring module software for providing GUIs for users and tutors, wherein the tutoring module software including whiteboard module software for providing a common template that both a tutor and a student can use to write and draw to interact with one another.

2. The system of claim 1, wherein the queuing module includes an algorithm that matches an available tutor to a student with a highest priority, said algorithm comprising:
an assigned Affiliate Threshold (AT) that reflects a priority for an affiliate institution that uses the system;
an assigned Subject Weight (SW) for each subject taught by a tutor, wherein the SW reflects the proficiency of the tutor in the subject;
instructions for calculating a Threshold Capacity (TC) for each student in a queue seeking assistance in a certain subject when a tutor for the subject becomes available, wherein TC is calculated by summing an AT of each student with a SW of the tutor in the subject;
instructions for calculating a Waiting Threshold (WT) for each of the students in the queue by dividing a time in queue for each of the students by the calculated TC; and
instructions for calculating a Student Priority (SP) for each of the students by dividing the TC of each of the students by the SW of the tutor in the certain subject, wherein a student with a highest SP is determined to have the highest priority.

3. The system of claim 1, wherein the tutoring module software interface for a tutor includes interface elements to allow the tutor to switch between a plurality of tutoring duties.

4. The system of claim 3, wherein said interface element is selected from the group consisting of icons, hypertext links, menus, and combinations thereof.

5. The system of claim 3, wherein said plurality of duties are selected from the group consisting of synchronous tutoring sessions, asynchronous tutoring sessions, annotation of previously-saved tutoring sessions, and transfer of a tutoring request to another tutor.

6. The system of claim 1, wherein the tutoring module software interface for a student includes a display of an estimated wait time.

7. The system of claim 6, wherein the tutoring module software interface for a student includes software to view stored content while waiting for a tutor.

8. The system of claim 7, wherein said stored content is selected from the group consisting of documents, movies, audio, and combinations thereof

9. The system of claim 1, wherein the tutoring module software includes instructions and interface elements to allow students and tutors to import external content into the common template.

10. A method for providing a tutoring service over a network, comprising
providing a tutoring application server on the network;
serving one or more student interfaces over the network;
serving one or more tutoring interfaces over the network;
wherein the tutoring application server:
matches an available tutor in a subject to a student seeking assistance in the subject with a highest priority; and
provides a common template that both a matched tutor and student can use to write and draw to interact with one another.

11. The method of claim 10, wherein the tutoring application server matches the tutor and student with a queuing module and provides the common template with a tutoring module.

12. The method of claim 10, further comprising matching an available tutor to a student with a highest priority by:
assigning an Affiliate Threshold (AT) that reflects a priority for an affiliate institution that uses the system;
assigning a Subject Weight (SW) for each subject taught by a tutor, wherein the SW reflects the proficiency of the tutor in the subject;
calculating a Threshold Capacity (TC) for each student in a queue seeking assistance in a certain subject when a tutor for the subject becomes available, wherein TC is calculated by summing an AT of each student with a SW of the tutor in the subject;
calculating a Waiting Threshold (WT) for each of the students in the queue by dividing a time in queue for each of the students by the calculated TC; and
calculating a Student Priority (SP) for each of the students by dividing the TC of each of the students by the SW of the tutor in the certain subject, wherein a student with a highest SP is determined to have the highest priority.

13. The method of claim 10, further comprising providing interface elements to allow the tutor to switch between a plurality of tutoring duties.

14. The method of claim 13, wherein said interface elements are selected from the group consisting of icons, hypertext links, menus, and combinations thereof.

15. The method of claim 13, wherein said plurality of duties are selected from the group consisting of synchronous tutoring sessions, asynchronous tutoring sessions, annotation of previously-saved tutoring sessions, and transfer of a tutoring request to another tutor.

16. The method of claim 10, further comprising displaying an estimated wait time to each student.

17. The method of claim 16, further comprising students viewing stored content while waiting for a tutor.

18. The method of claim 17, wherein said stored content is selected from the group consisting of documents, movies, audio, and combinations thereof.

19. The method of claim 10, further comprising allowing students and tutors to import external content into the common template.

20. The method of claim 19, further comprising importing the external content in content windows and allowing resizing and annotation of each content window.

21. The method of claim 10, wherein the student seeks assistance in the subject by posting a question to the system and the student can exit the queue and request an asynchronous response from a tutor.

22. The method of claim 10, wherein interaction on the common template is saved for review by the tutor, the student, and an Affiliate.

23. The method of claim 10, wherein the saved interaction is post processed by the tutor to make corrections or add comments.

24. The method of claim 10, wherein the student interface served over the network is a student homepage and the student seeks assistance in the subject and accesses the common template using the homepage.

25. The method of claim 10, wherein the student interface served over the network is the common template and the student seeks assistance in the subject using a local software module to contact the tutoring application server.

26. The method of claim 21, further comprising customizing and controlling exit privileges of the student with an XML file.
